(19) United States
(12) Patent Application Publication
(10) Pub. No.: US 2011/0206294 A1
(43) Pub. Date: Aug. 25, 2011

(54) Image Processing Apparatus, Image Processing Method, and Program

(76) Inventors: Masatoshi YOKOKAWA, Kanagawa (JP); Kazuki Aisaka, Kanagawa (JP); Nodoka Tokunaga, Tokyo (JP); Jun Murayama, Tokyo (JP)

(21) Appl. No.: 13/005,592

(22) Filed: Jan. 13, 2011

(30) Foreign Application Priority Data
Feb. 25, 2010 (JP) P2010-040699

(51) Int. Cl. G06K 9/36

(52) U.S. Cl. 382/276

(57) ABSTRACT

An image processing apparatus includes: an input image energy map generation unit generating an input image energy map from an input image; a reduced energy map generation unit generating a reduced energy map; a reduction seam search unit searching a reduction seam formed by binding pixels of a path along which a cumulative energy value of energies of pixels is minimum; a partial seam search unit searching a partial seam formed by binding pixels with a minimum cumulative value; an input image energy map update unit updating the input image energy map by inserting and replacing a maximum energy value into the energies corresponding to all of the pixels of the input image on the input image energy map; and a reduction expansion unit reducing or expanding the input image by deleting the pixels forming the partial seam from the input image.

### BACKGROUND OF THE INVENTION

1. Field of the Invention

The present invention relates to an image processing apparatus, an image processing method, and a program, and more particularly, to an image processing apparatus, an image processing method, and a program capable of resolving a defect of seam carving and performing processing at high speed.

2. Description of the Related Art

An image processing technique called seam carving has generally come into use.

Seam carving is a technique for expanding or reducing an image so as to prevent the shape or size of an object which is a subject in the image from being unnatural. More specifically, in the seam carving, the energy of each pixel is first calculated from difference between the pixel values or luminance values between pixels of an image, and an energy image (energy map) is generated from the energies. Next, among paths from respective pixels located at one end of the energy image to the pixels located at the other end of the energy image via the sequentially adjacent pixels from the pixel located at the one end of the energy image, a path along which the cumulative value of the energies of pixels is the minimum is selected as a seam. In the adjacent pixels forming the seam, it is considered that a variation in the pixel value or the luminance value is small. That is, since the seam is an area where the pixels with small energy variation are sequentially arranged, it can be considered that the areas adjacent to the pixels forming the seam are areas with the pixel value or the luminance value which is the same as the pixels forming the seam. In the seam carving, the size of the entire image is reduced or expanded while allowing the variation in the shape or size of an object which is a subject in the image to be small by deleting or adding the pixels organizing the seam from an input image (see Japanese Unexamined Patent Application Publication No. 2008-217765).

### SUMMARY OF THE INVENTION

In the seam carving, an energy image with the same size as that of an image is generated and a seam with the least energy variation is searched from the entire image. Therefore, when a seam subsequent to the second seam is searched, the searched seam is deleted to reconstruct the image every time one seam is searched and the energy image is regenerated each time, thereby causing high calculation cost.

When the once generated energy image is repeatedly used to suppress the regeneration of the energy image, a plurality of seams is simultaneously deleted from the same energy image. In this case, however, when the plurality of seams intersect each other, the same pixel at the intersection point generated when the plurality of seams intersect each other is included in the plurality of seams on the assumption that the width deleted by one seam is one pixel. At this time, when the plurality of seams is simultaneously deleted or added, a problem may arise in that the number of pixels in the row or column including the intersection point may be different from the number of pixels in another row or column, that is, a pixel difference may occur.

It is desirable to provide a technique for preventing the pixel difference, while reducing the calculation cost particularly in seam carving.

According to an embodiment of the invention, there is provided an image processing apparatus including: input image energy map generation means for generating an input image energy map from an input image based on energies of adjacent pixels of the input image; reduced energy map generation means for generating a reduced energy map corresponding to a reduced image, which is formed by setting one block formed by a plurality of adjacent pixels of the input image as one pixel, by reducing the input image energy map; reduction seam search means for searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map; partial seam search means for searching a partial seam formed by binding pixels with a minimum cumulative value among a plurality of paths formed from a pixel located at one end, which forms an end of the reduction seam searched by the reduction seam search means, of the input image in the input image energy map to pixels located at the other end of the input image sequentially via the pixels adjacent in a direction of the other end; input image energy map update means for updating the input image energy map by inserting and replacing a maximum energy value into the energies corresponding to all of the pixels, which form the partial seam searched by the partial seam search means, of the input image on the input image energy map; and reduction expansion means for reducing or expanding the input image by deleting the pixels forming the partial seam searched by the partial seam search means from the input image or inserting pixels interpolated from the same pixels as neighboring pixels to the pixels forming the partial seam. When searching the plurality of paths formed from the pixel located at the one end of the input image to the pixels located at the other end of the input image sequentially via the pixels adjacent in the direction of the other end, the partial seam search means forms the paths by setting the pixels with the minimum energy as the adjacent pixels among a predetermined number of pixels adjacent to the adjacent pixels when all of the adjacent pixels have the maximum energy value of the input image energy map.

The image processing apparatus may further include reduction image energy map update means for updating the reduced image energy map by inserting and replacing the maximum energy value into the energies corresponding to all of the pixels, which form the reduction seam searched by the reduction seam search means, of the reduced image on the reduced image energy map.

According to a greedy method or a dynamic programming method, the reduction seam search means may search the reduction seam formed by binding pixels of the path along which the cumulative energy value is minimum among the plurality of paths formed from the pixel located at one end of the reduced image to the pixels at the other end of the reduced image sequentially via the pixels adjacent in the direction of the other end in the reduced energy map.

According to a greedy method, the partial seam search unit may search the partial seam formed by binding the pixels with the minimum cumulative value of the energies of the pixels among the plurality of paths formed from the pixel located at one end, which forms the end of the reduction seam searched by the reduction seam search means, of the input image in the input image energy map to the pixels located at the other end of the input image sequentially via the pixels adjacent in the direction of the other end.

According to another embodiment of the invention, there is provided an image processing method of an image processing apparatus which includes input image energy map generation means for generating an input image energy map from an input image based on energies of adjacent pixels of the input image, reduced energy map generation means for generating a reduced energy map corresponding to a reduced image, which is formed by setting one block formed by a plurality of adjacent pixels of the input image as one pixel, by reducing the input image energy map, reduction seam search means for searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map, partial seam search means for searching a partial seam formed by binding pixels with a minimum cumulative value among a plurality of paths formed from a pixel located at one end, which forms an end of the reduction seam searched by the reduction seam search means, of the input image in the input image energy map to pixels located at the other end of the input image sequentially via the pixels adjacent in a direction of the other end, input image energy map update means for updating the input image energy map by inserting and replacing a maximum energy value into the energies corresponding to all of the pixels, which form the partial seam searched by the partial seam search means, of the input image on the input image energy map, and reduction expansion means for reducing or expanding the input image by deleting the pixels forming the partial seam searched by the partial seam search means from the input image or inserting pixels interpolated from the same pixels as neighboring pixels to the pixels forming the partial seam, wherein when searching the plurality of paths formed from the pixel located at the one end of the input image to the pixels located at the other end of the input image sequentially via the pixels adjacent in the direction of the other end, the partial seam search means forms the paths by setting the pixels with the minimum energy as the adjacent pixels among a predetermined number of pixels adjacent to the adjacent pixels when all of the adjacent pixels have the maximum energy value of the input image energy map. The image processing method includes the steps of: generating, by the input image energy map generation means, the input image energy map from the input image based on the energies of the adjacent pixels of the input image; generating, by the reduced energy map generation means, the reduced energy map corresponding to the reduced image, which is formed by setting one block formed by the plurality of adjacent pixels of the input image as one pixel, by reducing the input image energy map; searching, by the reduction seam search means, the reduction seam formed by binding the pixels of the path along which the cumulative energy value is minimum among the plurality of paths formed from the pixel located at one end of the reduced image to pixels located at the other end of the reduced image sequentially via the pixels adjacent in the direction of the other end in the reduced energy map; searching, by the partial seam search means, the partial seam formed by binding the pixels with the minimum cumulative value of the energies of the pixels among the plurality of paths formed from the pixel located at one end, which forms an end of the reduction seam searched in the step of searching the reduction seam, of the input image in the input image energy map to the pixels located at the other end of the input image sequentially via the pixels adjacent in the direction of the other end; updating, by the input image energy map update means, the input image energy map by inserting and replacing the maximum energy value into the energies corresponding to all of the pixels, which form the partial seam searched in the step of searching the partial seam, of the input image on the input image energy map; and reducing or expanding, by the reduction expansion means, the input image by deleting the pixels forming the partial seam searched in the step of searching the partial seam from the input image or inserting the pixels interpolated from the same pixels as the neighboring pixels to the pixels forming the partial seam. When searching the plurality of paths formed from the pixel located at the one end of the input image to the pixels located at the other end of the input image sequentially via the pixels adjacent in the direction of the other end, the paths are formed in the step of searching the partial seam by setting the pixels with the minimum energy as the adjacent pixels among the predetermined number of pixels adjacent to the adjacent pixels when all of the adjacent pixels have the maximum energy value of the input image energy map.

According to still another embodiment of the invention, there is provided a program causing a computer controlling an image processing apparatus which includes input image energy map generation means for generating an input image energy map from an input image based on energies of adjacent pixels of the input image, reduced energy map generation means for generating a reduced energy map corresponding to a reduced image, which is formed by setting one block formed by a plurality of adjacent pixels of the input image as one pixel, by reducing the input image energy map, reduction seam search means for searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map, partial seam search means for searching a partial seam formed by binding pixels with a minimum cumulative value among a plurality of paths formed from a pixel located at one end, which forms an end of the reduction seam searched by the reduction seam search means, of the input image in the input image energy map to pixels located at the other end of the input image sequentially via the pixels adjacent in a direction of the other end, input image energy map update means for updating the input image energy map by inserting and replacing a maximum energy value into the energies corresponding to all of the pixels, which form the partial seam searched by the partial seam search means, of the input image on the input image energy map, and reduction expansion means for reducing or expanding the input image by deleting the pixels forming the partial seam searched by the partial seam search means from the input image or inserting pixels interpolated from the same pixels as neighboring pixels to the pixels forming the partial seam, wherein when searching the plurality of paths formed from the pixel located at the one end of the input image to the pixels located at the other end of the input image sequentially via the pixels adjacent in the direction of the other end, the partial seam search means forms the paths by setting the pixels with the minimum energy as the adjacent pixels among a predetermined number of pixels adjacent to the adjacent pixels when all of the adjacent pixels have the maximum energy value of the input image energy map, to execute the steps of: generating, by the input image energy map generation means, the input image energy map from the input image based on the energies of the adjacent pixels of the input image; generating, by the reduced energy map generation means, the reduced energy map corresponding to the reduced image, which is formed by setting one block formed by the plurality of adjacent pixels of the input image as one pixel, by reducing the input image energy map; searching, by the reduction seam search means, the reduction seam formed by binding the pixels of the path along which the cumulative energy value is minimum among the plurality of paths formed from the pixel located at one end of the reduced image to pixels located at the other end of the reduced image sequentially via the pixels adjacent in the direction of the other end in the reduced energy map; searching, by the partial seam search means, the partial seam formed by binding the pixels with the minimum cumulative value of the energies of the pixels among the plurality of paths formed from the pixel located at one end, which forms an end of the reduction seam searched in the step of searching the reduction seam, of the input image in the input image energy map to the pixels located at the other end of the input image sequentially via the pixels adjacent in the direction of the other end; updating, by the input image energy map update means, the input image energy map by inserting and replacing the maximum energy value into the energies corresponding to all of the pixels, which form the partial seam searched in the step of searching the partial seam, of the input image on the input image energy map; and reducing or expanding, by the reduction expansion means, the input image by deleting the pixels forming the partial seam searched in the step of searching the partial seam from the input image or inserting the pixels interpolated from the same pixels as the neighboring pixels to the pixels forming the partial seam. When searching the plurality of paths formed from the pixel located at the one end of the input image to the pixels located at the other end of the input image sequentially via the pixels adjacent in the direction of the other end, the paths are formed in the step of searching the partial seam by setting the pixels with the minimum energy as the adjacent pixels among the predetermined number of pixels adjacent to the adjacent pixels when all of the adjacent pixels have the maximum energy value of the input image energy map.

According to still another embodiment of the invention, an input image energy map is generated from an input image based on energies of adjacent pixels of the input image; a reduced energy map corresponding to a reduced image, which is formed by setting one block formed by a plurality of adjacent pixels of the input image as one pixel, is generated by reducing the input image energy map; a reduction seam is searched which is formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map; a partial seam is searched which is formed by binding pixels with a minimum cumulative value among a plurality of paths formed from a pixel located at one end, which forms an end of the reduction seam searched by the reduction seam search unit, of the input image in the input image energy map to pixels located at the other end of the input image sequentially via the pixels adjacent in a direction of the other end; the input image energy map is updated by inserting and replacing a maximum energy value into the energies corresponding to all of the pixels, which form the partial seam searched by the partial seam search unit, of the input image on the input image energy map; and the input image is reduced or expanded by deleting the pixels forming the partial seam searched by the partial seam search unit from the input image or inserting pixels interpolated from the same pixels as neighboring pixels to the pixels forming the partial seam. When searching the plurality of paths formed from the pixel located at the one end of the input image to the pixels located at the other end of the input image sequentially via the pixels adjacent in the direction of the other end, the paths are formed by setting the pixels with the minimum energy as the adjacent pixels among a predetermined number of pixels adjacent to the adjacent pixels when all of the adjacent pixels have the maximum energy value of the input image energy map.

The image processing apparatus according to the embodiments of the invention may be an independent apparatus or a block performing image processing.

According to the embodiment of the invention, it is possible to reduce the pixel difference, while reducing the calculation cost.

### BRIEF DESCRIPTION OF THE DRAWINGS

FIG. 1 is a block diagram illustrating an exemplary configuration of an image processing apparatus according to an embodiment of the invention.

FIG. 2 is a block diagram illustrating an exemplary configuration of a search unit in FIG. 1.

FIG. 3 is a flowchart illustrating a seam carving process.

FIG. 4 is a flowchart illustrating a search process. FIG. 5 is a flowchart illustrating a process of searching the entire image.

FIG. 6 is a diagram illustrating the process of searching the entire image.

FIG. 7 is a diagram illustrating the process of searching the entire image.

FIG. 8 is a diagram illustrating the process of searching the entire image.

FIG. 9 is a flowchart illustrating a process of searching a partial image.

FIG. 10 is a diagram illustrating the process of searching the partial image.

FIG. 11 is a diagram illustrating the process of searching the partial image.

FIG. 12 is a diagram illustrating the process of searching the partial image.

FIG. 13 is a diagram illustrating the process of searching the partial image.

FIG. 14 is a diagram illustrating the process of searching the partial image.

FIG. 15 is a diagram illustrating a dynamic programming method and a greedy method in the search process.

FIG. 16 is a diagram illustrating the processing result of the seam carving process.

FIG. 17 is a diagram illustrating an exemplary configuration of a general personal computer.

### DESCRIPTION OF THE PREFERRED EMBODIMENTS

### Exemplary Configuration of Image Processing Apparatus

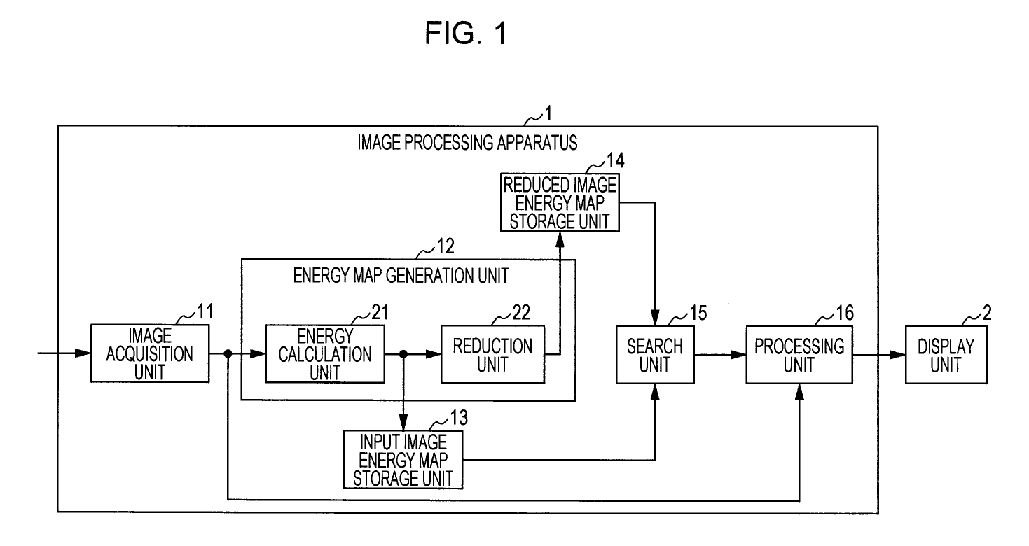

FIG. 1 is a diagram illustrating an exemplary configuration of a hardware image processing apparatus according to an embodiment of the invention. The image processing apparatus 1 in FIG. 1 reduces or expands an input image by seam carving and displays the expanded or reduced image on a display unit 2.

The image processing apparatus 1 includes an image acquisition unit 11, an energy map generation unit 12, an input image energy map storage unit 13, a reduced image energy map storage unit 14, a search unit 15, and a processing unit 16.

The image acquisition unit 11 acquires the input image and supplies the input image to the energy map generation unit 12 and the processing unit 16. The energy map generation unit 12 includes an energy calculation unit 21 and a reduction unit 22. The energy map generation unit 12 generates an input image energy map with the same size as that of the input image and a reduced image energy map with the same size as that of the reduced image of the input image from the input image supplied from the image acquisition unit 11. More, specifically, the energy calculation unit 21 calculates energy e(I) of each pixel by Expression (1) below, generates an input image energy map from the energy of a pixel unit so as to correspond to the input image, and stores the input image energy map in the storage unit 13. The energy calculation unit 21 supplies the generated input image energy map to the reduction unit 22.

$$e ( I ) = \vert \frac{\partial }{\partial x} I \vert + \vert \frac{\partial }{\partial y} I \vert \qquad ( 1 )$$

In this expression, e(I) represents the energy of each pixel at a position on the input image indicated by I. That is, the energy e(I) of each pixel expressed by Expression (1) indicates the absolute sum of a difference between the pixel values, the luminance values, or the like of the pixels adjacent to each other in x and y directions in each pixel of the input image.

The reduction unit 22 reduces the input image energy map, which is calculated and generated by the energy calculation unit 21 and has the same size as that of the input image, to generate a reduced image energy map and stores the reduced image energy map in the reduced image energy map storage unit 14. More specifically, the reduction unit 22 generates the reduced image energy map by setting, for example, m by n pixels of the input image as one block, calculating the average value or the intermediate value of the energy of the pixels of each block so that the one block corresponds to one pixel, and constructing the energy map. That is, the reduced image energy map is calculated as an energy map of the reduced image generated so that m by n pixels of the input image are set as one block and the one block corresponds to one pixel.

The search unit 15 reads the reduced image energy map from the reduced image energy map storage unit 14, selects the sequentially adjacent pixels from one end of the reduced image to the other end thereof as a selection path, and searches a reduction seam so that the cumulative value of the energies of the pixels of the selection path is the minimum. In this case, the search unit 15 searches the reduction seam according to a dynamic programming method or a greedy method described below. The search unit 15 replaces the energy of the pixels belonging to the temporarily calculated reduction seam by the maximum energy value and repeatedly performs the same processing until a predetermined number of partial seams are sequentially calculated.

Here, the path formed by the sequentially adjacent pixels from one end of the reduced image to the other end thereof is a path formed by connecting the sequentially selected pixels from one of the pixels located at the upper end of the reduced image to one of the pixels located at the lower end of the reduced image via the pixels selected sequentially and repeatedly in the selection procedure in which one pixel is selected from three pixels adjacent right below, immediately below, and left below one pixel. Accordingly, when one end is the left end of the reduced image and the other end is the right end of the reduced image, a path is formed by connecting the sequentially selected pixels from one of the pixels located at the left end of the reduced image to one of the pixels located at the right end of the reduced image via the pixels selected sequentially and repeatedly in the selection procedure in which one pixel is selected from three pixels adjacent right above, immediately right, and right below one pixel. Hereinafter, when the reduction seam is searched from the upper end of the reduced image to the lower end thereof, a search direction is called a downward direction. When the reduction seam is searched from the left end of the reduced image to the right end thereof, a search direction is called a rightward direction. In a case where a pixel of interest is set, pixels adjacent to the pixel of interest in the search direction are three pixels adjacent right above, immediately above, and left above the pixel of interest or are three pixels adjacent right below, immediately below, and left below the pixel of interest when the search direction is a vertical direction. Similarly, when the search direction is a horizontal direction, pixels adjacent to the pixel of interest in the search direction are three pixels adjacent left above, immediately left, and left below the pixel of interest or are three pixels located right above, immediately right, and right below the pixel of interest.

The search unit 15 sets the pixels with the minimum energy sequentially as the pixel of interest among the pixels which belong to the block corresponding to the pixels of the reduced image forming the reduction seam searched with the reduced image energy map and are sequentially adjacent from the pixel located at the end of the input image. The search unit 15 searches the partial seam by binding the sequentially set pixels of interest. At this time, the search unit 15 searches the partial seam according to the greedy method described below. Then, the search unit 15 replaces the energy corresponding to the pixel belonging to the temporarily calculated partial seam of the input image by the maximum energy value and repeats the same processing until the search unit 15 sequentially calculates the predetermined number of partial seams to calculate the plurality of partial seams.

The processing unit 16 reduces or expands the image by deleting or adding the pixels corresponding to the partial seams calculated by the search unit 15 from the image supplied from the image acquisition unit 11, and then outputs the reduced or expanded image to the display unit 2 to display the reduced or expanded image.

### Exemplary Configuration of Search Unit 15

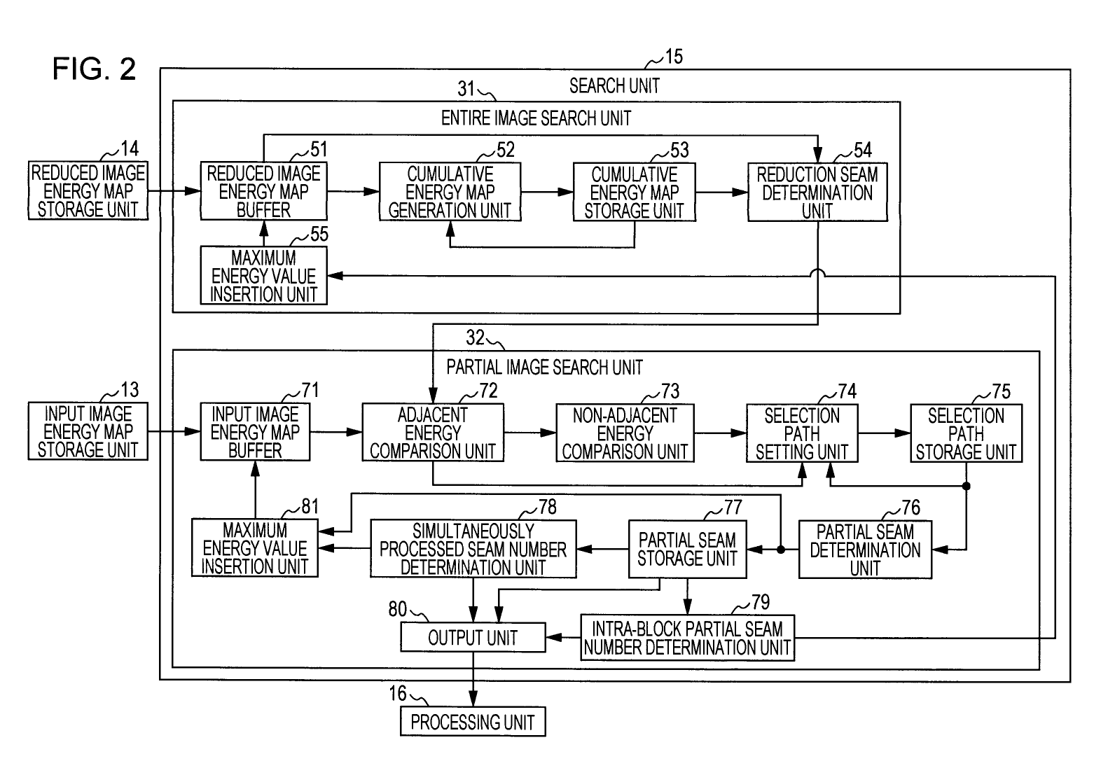

Next, an exemplary configuration of the search unit 15 will be described in detail with reference to FIG. 2.

The search unit 15 includes an entire image search unit 31 and a partial image search unit 32. The entire image search unit 31 calculates the reduction seam of the reduced image from the reduced image energy map and supplies the reduction seam to the partial image search unit 32. The partial image search unit 32 calculates the partial seam from the input image energy map based on information regarding the reduction seam supplied from the entire image search unit 31, and outputs the partial seam to the processing unit 16.

First, the configuration of the entire image search unit 31 will be described. The entire image search unit 31 includes a reduced image energy map buffer 51, a cumulative energy map generation unit 52, a cumulative energy map storage unit 53, a reduction seam determination unit 54, and a maximum energy value insertion unit 55. The reduced image energy map buffer 51 reads and temporarily stores the reduced image energy map stored in the reduced image energy map storage unit 14. When the energies of the pixels belonging to the reduction seam are replaced by the maximum energy value inserted from the maximum energy value insertion unit 55 and the reduced image energy map is updated, the reduced image energy map buffer 51 stores the updated reduced image energy map.

The cumulative energy map generation unit 52 sequentially cumulates the energies of the pixels adjacent to the sequentially set pixels of interest in a direction reverse to the search direction of the reduced image energy map by performing calculation of Expression (2) below, and calculates the energies as a cumulative energy.

M(i, j)=e(i, j)+min(M(i−1, j−1), M(i−1, j), M(i−1, j+1)) (2)

In this expression, M(i, j) represents a cumulative energy of the sequentially set pixels of interest (i, j). In addition, e(i, j) represents the energy of the pixel of interest (i, j). In addition, min(A, B, C) represents selection of the minimum value from among A to C.

That is, the cumulative energy map generation unit 52 calculates the cumulative energy of the pixel of interest (i, j) by selecting the minimum energy from among the cumulative energies M (i−1, j−1), M(i−1, j), and M(i−1, j+1) of the pixels (i−1, j−1), (i−1, j), and (i−1, j+1) adjacent to the pixel of interest (i, j) in a direction reverse to the search direction of the reduction seam and adding the minimum energy to the energy of the pixel of interest. The cumulative energy map generation unit 52 generates the cumulative energy map of the reduced image energy map by sequentially repeating the same processing and stores the cumulative energy map in the cumulative energy map storage unit 53. In Expression (2), an example is shown in which the reduction seam is searched from the upper end of the input image to the lower end thereof in the vertical direction. Therefore, Expression (2) varies so as to correspond to the search direction of the reduction seam.

Based on information regarding the cumulative energy map stored in the cumulative energy map storage unit 53, the reduction seam determination unit 54 searches the reduction seam so that the cumulative value of the energies of the pixels selected as the selection path from the pixel located at one end of the reduced image is the minimum. The reduction seam determination unit 54 determines, as the reduction seam, the path binding the pixels of which the cumulative energy is the minimum, and supplies the determined reduction seam to the partial image search unit 32. The reduction seam determination unit 54 supplies information regarding the determined reduction seam to the maximum energy value insertion unit 55.

The maximum energy value insertion unit 55 inserts the maximum energy value into the energies of the pixels belonging to the reduction seam among the energies of the pixels of the reduced energy maps stored in the reduced energy map buffer 51 to update the energy. That is, energy is expressed by a finite numerical value, but is rarely expressed by the maximum value. In effect, since the energy expresses the fact that the pixel is selected as a pixel forming the reduction seam, the maximum energy value different from the actual value is inserted.

Next, the configuration of the partial image search unit 32 will be described. The partial image search unit 32 includes an input image energy map buffer 71, an adjacent energy comparison unit 72, a non-adjacent energy comparison unit 73, a selection path setting unit 74, a selection path storage unit 75, a partial seam determination unit 76, and a partial seam storage unit 77. The partial image search unit 32 also includes a simultaneously processed seam number determination unit 78, an intra-block partial seam number determination unit 79, an output unit 80, and a maximum energy value insertion unit 81.

The input image energy map buffer 71 reads and temporarily stores information regarding the input image energy map stored in the input image energy storage unit 13. The input image energy map buffer 71 updates and stores the input image energy map in which the maximum energy value is inserted into the energies of the pixels belonging to the calculated partial seam and the values of the energies of the pixels are replaced with the maximum energy value by the maximum energy value insertion unit 81.

The adjacent energy comparison unit 72 sequentially sets the pixels of interest from the pixel located at one end, among the pixels of the input image which belong to the block at the one end, in the block forming the reduction seam supplied from the entire image search unit 31. Then, the adjacent energy comparison unit 72 compares the maximum energy value to the energies of the pixels adjacent to the sequentially set pixels of interest in the search direction, and determines whether all of the energies of the adjacent pixels are only the maximum energy value. The adjacent energy comparison unit 72 supplies the determination result obtained when all of the energies of the adjacent pixels have the maximum energy value to the non-adjacent energy comparison unit 73 depending on the determination result.

When all of the pixels adjacent to the pixel of interest are the maximum energy value in the determination result of the adjacent energy comparison unit 72, the non-adjacent energy comparison unit 73 selects, as adjacent pixels, pixels which are not adjacent to the pixel of interest depending on the position of the pixel of interest and supplies the selected adjacent pixels to the selection path setting unit 74. That is, the non-adjacent energy comparison unit 73 selects, as the adjacent pixels, the plurality of pixels which are not adjacent to the pixel of interest but are adjacent to the pixels adjacent to the pixel of interest.

Based on the information regarding the input image map stored in the input image energy map buffer 71 and the information regarding the pixels set as the adjacent pixels supplied from the non-adjacent energy comparison unit 73, the selection path setting unit 74 sets the pixels with the minimum energy sequentially in the selection direction among the pixels adjacent in the direction from one end of the reduction seam to the other end thereof in the pixels of the input image which belong to the reduction seam. The selection path setting unit 74 stores the set pixels with the minimum energy in the selection path storage unit 75.

The partial seam determination unit 76 determines, as a partial seam, the path along which the cumulative energy of the pixels stored in the selection path storage unit 75 and present in the selection direction is the minimum, from the respective pixels, which are stored in the selection path storage unit 75, belonging to the reduction seam and being present at one end of the input image. The partial seam determination unit 76 stores information regarding the determined partial seam in the partial seam storage unit 77.

Based on the information regarding the partial seam stored in the partial seam storage unit 77, the simultaneously processed seam number determination unit 78 determines whether the number of partial seams reaches a preset seam number of partial seams which can be simultaneously processed. Then, when the number of partial seams does not reach the seam number of partial seams which can be simultaneously processed, the simultaneously processed seam number determination unit 78 notifies the maximum energy value insertion unit 81 of the result. The simultaneously processed seam number determination unit 78 inserts and updates the maximum energy value into the energy of a pixel belonging to the partial seam newly stored in the input image energy map and searches a new partial seam. When the number of partial seams reaches the seam number of partial seams which can be simultaneously processed, the simultaneously processed seam number determination unit 78 notifies the output unit 80 of the result and outputs the information regarding the partial seams stored in the partial seam storage unit 77 from the output unit 80 to the processing unit 16.

The intra-block partial seam number determination unit 79 determines whether the number of current partial seams reaches a preset number by a reduced block unit formed by the pixels forming the reduced image in which the reduction seam is calculated. When the number of current partial seams reaches the preset number, the intra-block partial seam number determination unit 79 notifies the entire image search unit 31 when the entire image search unit 31 searches a new reduction seam.

### Seam Carving Process

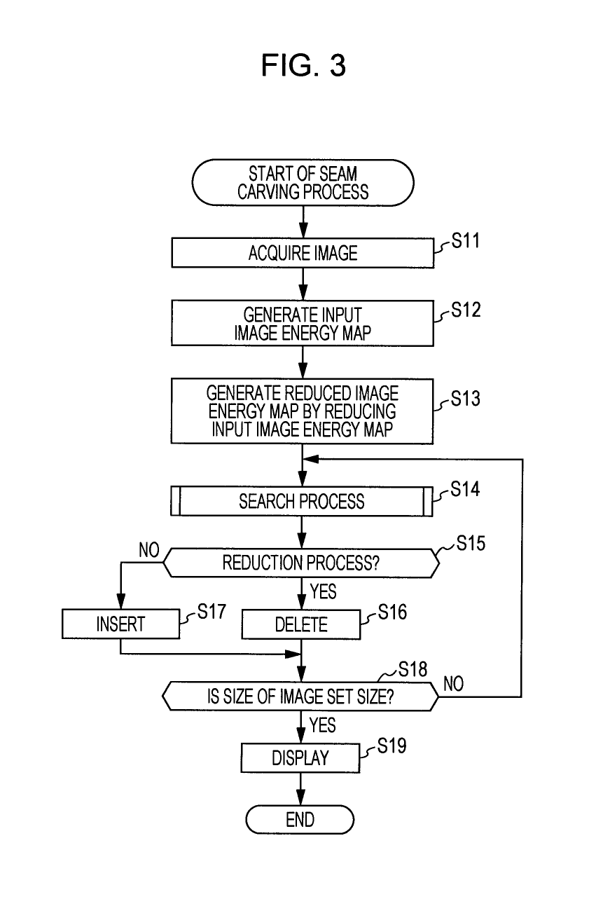

Next, the seam carving process will be described with reference to the flowchart of FIG. 3.

In step S1, the image acquisition unit 11 acquires the input image and supplies the acquired input image to the energy map generation unit 12 and the processing unit 16.

In step S12, the energy map generation unit 12 controls the energy calculation unit 21 to calculate the energy of each pixel by calculating Expression (1) described above based on the pixel value, the luminance value, or the like of each pixel of the input image. Moreover, the energy map generation unit 12 controls the energy calculation unit 21 to generate the input image energy map from the values of the energies calculated by each pixel unit. Then, the energy map generation unit 12 stores the input image energy map in the input image energy map storage unit 13 and supplies the input image energy map to the reduction unit 22.

In step S13, the energy map generation unit 12 generates the reduced image energy map by controlling the reduction unit 22 and processing the energy map so as to have the size of the reduced image, and stores the reduced image energy map in the reduced image energy map storage unit 14. More specifically, the reduction unit 22 forms the input image energy map into a block, for example, by a unit of m by n pixels and generates the reduced image energy map in which the average value, the intermediate value, or the like of the energies of the pixels forming each block is set as the energy corresponding to each pixel of the reduced image. In this example, the energy map corresponding to the reduced image is called the reduced image energy map. In effect, however, the reduced image energy map is the same as the energy map formed so that the input image energy map has a low resolution.

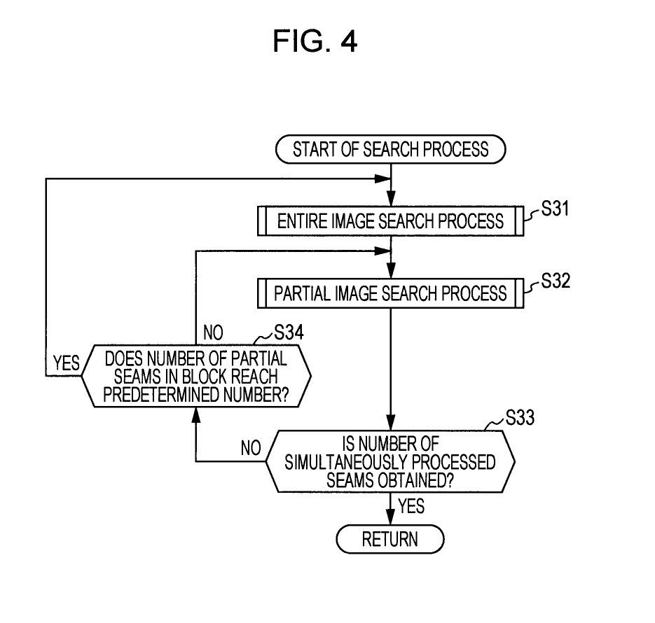

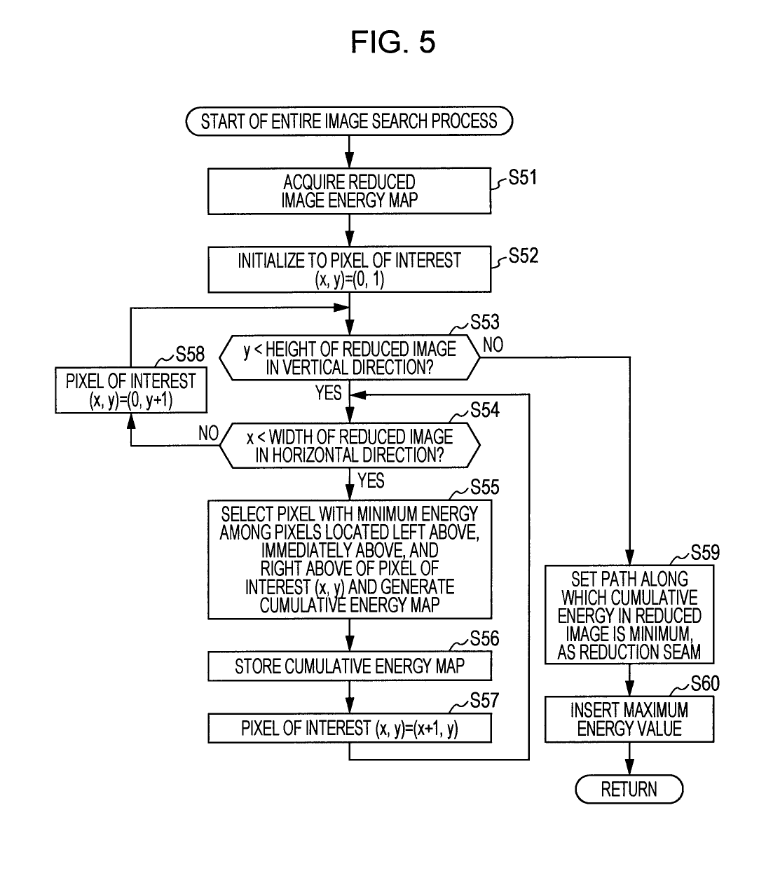

In step S14, the search unit 15 searches the predetermined number of partial seams by performing the search process based on the input image energy map of the input image energy map storage unit 13 and the reduced image energy map of the reduced image energy map storage unit 14. That is, the search unit 15 searches, as the predetermined number of partial seams, the paths along which a variation in the pixel value or the luminance value is small among the paths formed by the pixels adjacent in the horizontal direction (x direction) or the vertical direction (y direction) of the input image. Then, the search unit 15 supplies information regarding the predetermined number of partial seams to the processing unit 16. The search process will be described below with reference to the flowchart of FIG. 4.

In step S15, the processing unit 16 determines whether the processing on the input image by the seam carving of the input image is performed for the reduction process. For example, when it is determined that the processing is performed for the reduced image, the process proceeds to step S16.

In step S16, the processing unit 16 deletes the pixels forming the partial seams from the input image and fills the deleted area to reduce the image, based on the information of the partial seams.

On the other hand, when it is determined that the processing on the input by the seam carving of the input image is not performed for the reduction process in step S15, that is, when it is determined that the processing is performed for an expansion process, the process proceeds to step S17.

In step S17, the processing unit 16 expands the image by inserting the same pixels as those of the partial seams into the positions adjacent to the pixels forming the partial seams from the input image, based on the information regarding the partial seams.

In step S18, the processing unit 16 determines whether the size of the processed input image is a set size. For example, when it is determined that the size of the processed input image is not the size set by the reduction or the expansion in step S18, the process returns to step S14, and then the reduction or the expansion is repeated by the subsequent processes. On the other hand, when it is determined that the size of the processed input image is the size set by the reduction or the expansion in step S18, the processing unit 16 outputs and displays the image obtained by processing the input image on the display unit 2 in step S19.

The partial seams formed by the adjacent pixels in which a variation in the pixel value or the luminance value between the pixels is small (the cumulative energy which is the cumulative value of the energies is the minimum) are calculated for the input image through the above-described processes. The pixels forming the calculated partial seam is deleted or inserted from the input image. Since the process of reducing or expanding the input image is realized in this way, the entire size of the input image can be varied without changing the size of a main object in the image. In the above-mentioned example, the processing unit 16 expands the image by inserting the same pixels as those of the partial seam. However, the same image may not be inserted, as long as the pixels which are not unnatural to the pixels near the partial seam may be inserted. Therefore, for example, the image may be expanded by inserting the pixels generated through interpolation of the pixels near the pixels obtained as the partial seam into the positions near the pixels obtained as the partial seam.

### Search Process

Next, the search process will be described with reference to the flowchart of FIG. 4.

In the search process, the reduction seam is calculated in the reduced image by performing the entire image search process using the reduced image energy map in step S31. When the reduction seam is calculated, the partial image search process is performed in step S32 based on the reduction seam which is calculated by the entire image search process, so that the partial seam for the input image is calculated.

### Entire Image Search Process

Hereinafter, the entire image search process using the reduced image energy map will be described with reference to the flowchart of FIG. 5. Referring to the flowchart of FIG. 5, an example will be described in which the reduction seams sequentially binding the pixels adjacent to the pixels located at the upper end of a rectangular image and adjacent to the pixels located at the lower end thereof is calculated. Such a reduction seam is calculated to reduce or expand the image in the horizontal direction of the reduction image. Therefore, when the image is reduced in the vertical direction of the reduced image, it is necessary to calculate the reduction seams sequentially binding the pixels adjacent to the pixels located at the left end and adjacent to the pixels located at the right end in the same way.

In step S51, the reduced image energy map buffer 51 reads the reduced image energy map from the reduced image energy map storage unit 14 and temporarily stores the reduced image energy map.

In step S52, the cumulative energy map generation unit 52 sets a pixel of interest (x, y) in the reduced image energy map to (0, 1) for initialization. The coordinates set herein are determined on the assumption that the pixel located at the upper left end of a reduced image is the origin (0, 0), the rightward direction is positive for the x coordinate in the horizontal direction, and the downward direction is positive for the y coordinate in the vertical direction.

In step S53, the cumulative energy map generation unit 52 determines whether the y coordinate of the pixel of interest (x, y) is smaller than the height of the reduced image in the vertical direction. In the initial process, for example, in step S53, the y coordinate has no height in the vertical direction of the reduced image, and thus the process proceeds to step S54.

In step S54, the cumulative energy map generation unit 52 determines whether the x coordinate of the pixel of interest (x, y) is smaller than the width of the reduced image in the horizontal direction. When the x coordinate of the pixel of interest (x, y) is smaller than the width of the reduced image in the horizontal direction in step S54, the process proceeds to step S55.

In step S55, the cumulative energy map generation unit 52 selects the pixel having the minimum cumulative energy from among the energies of the pixel (x−1, y+1) located left above, the pixel (x, y+1) located immediately above, and the pixel (x+1, y+1) located right above the pixel of interest (x, y) in the reduced image energy map. The cumulative energy map generation unit 52 adds the cumulative energy of the selected pixel to the energy of the pixel of interest to calculate the cumulative energy of the pixel of interest.

In step S56, the cumulative energy map generation unit 52 stores the calculated cumulative energy as the cumulative energy of the pixel of interest in the cumulative energy map storage unit 53. When the pixel of interest is located below by one pixel from the upper end, the energy of the pixel located at the upper end is used as the cumulative energy.

In step S57, the cumulative energy map generation unit 52 increases the x coordinate of the pixel of interest (x, y) by one, and then the process returns to step S54. When the x coordinate of the pixel of interest (x, y) is not smaller than the width of the reduced image in the horizontal direction in step S54, that is, when all of the processes end in the horizontal direction, the process proceeds to step S58.

In step S58, the cumulative energy map generation unit 52 increases the y coordinate of the pixel of interest (x, y) by one, the process returns to step S53. That is, by repeating the processes from step S53 to step S58, the pixel having the minimum cumulative energy is selected from among the cumulative energies of three pixels adjacent to each pixel of the reduced image in a direction reverse to the search direction. Then, the selected cumulative energy is sequentially added to the energies of the respective pixels, and the cumulative energy maps are generated and stored in the cumulative energy map storage unit 53.

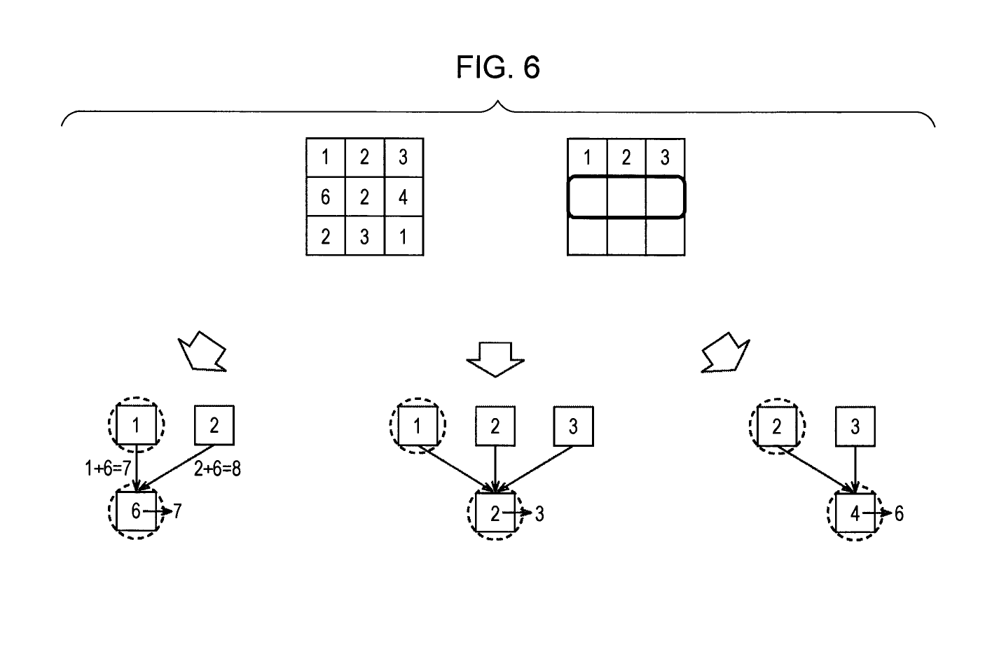

More specifically, on the assumption that the reduced image energy map of 3 by 3 pixels located at the left upper part in FIG. 6 is used, the following process is performed. The energies of the reduced image energy map at the left upper part in FIG. 6 are 1, 2, and 3 from the left side to the right side in the upper stage, are 6, 2, and 4 from the left side to the right side in the middle stage, and are 2, 3, and 1 from the left side to the right side in the lower stage.

The initial pixel of interest (x, y) is a pixel (0, 1) with energy 6 in the process of step S52. Since the pixel of interest (0, 1) is a pixel located at the left end, the pixel (0, 0) with the minimum cumulative energy is selected from among two pixels: a pixel (0, 0) with energy 1 located immediately above the pixel of interest and a pixel (1, 0) with energy 2 located right above the pixel of interest by the process of step S55. As shown in the left lower part of FIG. 6, the cumulative energy map generation unit 52 stores a cumulative value 7 of energy 1 (which is treated as cumulative energy herein) of the selected pixel (0, 0) and energy 6 of the pixel of interest (x, y), as the cumulative energy of the pixel of interest (x, y)=(0, 1) of the cumulative energy map in the cumulative energy map storage unit 53.

In the process of step S57, the x coordinate of the pixel of interest (x, y) is increased by one, and thus the energy of the pixel of interest (x, y) becomes energy 2 of a pixel (1, 1). In the process of step S55, as for the pixel of interest (1, 1), the pixel (0, 0) with the minimum cumulative energy is selected from among three pixels: the pixel (0, 0) with energy 1 located left above the pixel of interest (1, 1), the pixel (1, 0) with energy 2 located immediately above this pixel of interest, and the pixel (2, 0) with energy 3 located right above this pixel of interest. As shown in the lower middle part of FIG. 6, the cumulative energy map generation unit 52 stores a cumulative value 3 of energy 1 of the selected pixel (0, 0) and energy 2 of the pixel of interest (x, y) as the cumulative energy in the pixel of interest (x, y)=(1, 1) of the cumulative energy map in the cumulative energy map storage unit 53.

In the process of step S57, the x coordinate of the pixel of interest (x, y) is increased by one, and thus the energy of the pixel of interest (x, y) becomes energy 4 of a pixel (2, 1). Since the pixel of interest (2, 1) is a pixel at the right end, the pixel (2, 0) with the minimum cumulative energy is selected from between two pixels: a pixel (1, 0) with energy 2 located left above the pixel of interest and a pixel (2, 0) with energy 3 located immediately above the pixel of interest by the process of step S55. As shown in the right lower part of FIG. 6, the cumulative energy map generation unit 52 stores a cumulative value 6 of energy 2 of the selected pixel (1, 0) and energy 4 of the pixel of interest (x, y) as the cumulative energy in the pixel of interest (x, y)=(2, 1) of the cumulative energy map in the cumulative energy map storage unit 53.

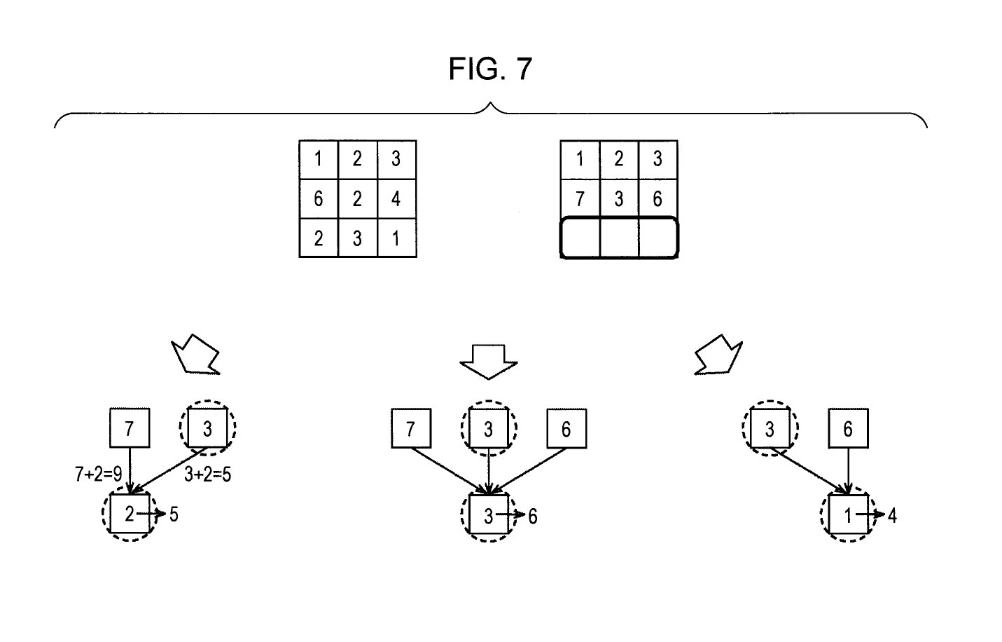

As a consequence, the cumulative energies of the middle stage in the second cumulative energy map are 7, 3, and 6 from the left side, as shown in the right upper part of FIG. 7. At this time, the x coordinate of the pixel of interest (x, y) is not smaller than the width (=2) of the reduced image in the horizontal direction, the respective pixels in the lower stage of the reduced image are sequentially set as the pixel of interest while the y coordinate is increased by one in step S58. The reduced image energy map is shown in the left upper part of FIG. 7.

In the same processes as the above-described processes, the cumulative energy of the pixel (0, 1) located immediately above the pixel of interest is 7 and the pixel (1, 1) located right above the pixel of interest is 3 based on the cumulative energy map, when the pixel of interest (x, y) is a pixel (0, 2). Accordingly, the pixel (1, 1) with the minimum cumulative energy 3 located right above the pixel of interest is selected. Then, cumulative energy 3 and energy 2 of the pixel of interest (x, y)=(0, 2) are cumulatively added, so that the cumulative energy of the pixel of interest (x, _{Y})=(0, 2) becomes 5 and is registered in the cumulative energy map.

Moreover, when the pixel of interest (x, y) is a pixel (1, 2), the cumulative energy of the pixel (0, 1) located left above the pixel of interest is 7, the cumulative energy of the pixel (1, 1) located immediately above the pixel of interest is 3, and the cumulative energy of the pixel (2, 1) located right above the pixel of interest is 6, based on the cumulative energy map. Accordingly, the pixel (1, 1) with the minimum cumulative energy 3 located immediately above the pixel of interest is selected. Then, cumulative energy 3 and energy 3 of the pixel of interest (x, y)=(1, 2) are cumulatively added, so that the cumulative energy of the pixel of interest (x, y)=(1, 2) becomes 6 and is registered in the cumulative energy map.

Furthermore, when the pixel of interest (x, y) is a pixel (2, 2), the cumulative energy of the pixel (1, 1) located left above the pixel of interest is 3 and the cumulative energy of the pixel (2, 1) located immediately above the pixel of interest is 6, based on the cumulative energy map. Accordingly, the pixel (1, 1) with the minimum cumulative energy 3 located left above the pixel of interest is selected. Then, cumulative energy 3 and energy 1 of the pixel of interest (x, y)=(2, 2) are cumulatively added, so that the cumulative energy of the pixel of interest (x, y)=(2, 2) becomes 4 and is registered in the cumulative energy map.

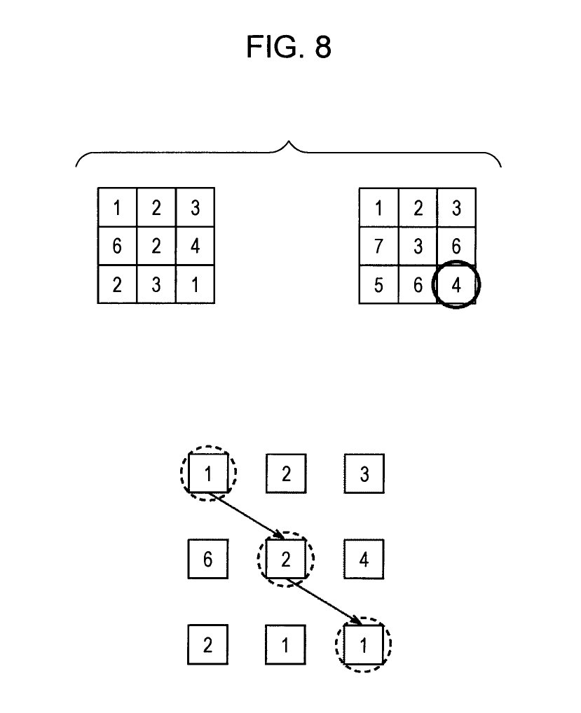

As a consequence, the cumulative energy map is constructed, as shown in the right upper part of FIG. 8 and the cumulative energies in the lower stage are 5, 6, and 4 from the left side. In the left upper part of FIG. 8, the reduced image energy map is shown.

Thus, for example, when the reduced image energy map shown in the left upper part of FIG. 8 is obtained by repeating the processes from step S53 to step S58, the cumulative energy map shown in the right upper part of FIG. 8 is calculated and is stored in the cumulative energy map storage unit 53.

Then, referring back to the flowchart of FIG. 5, the description will be made.

When it is determined that the y coordinate of the pixel of interest (x, y) is not smaller than the height of the reduced image in the vertical direction in step S53, that is, when the cumulative energy map is completed, as described above, and is considered to be stored in the cumulative energy map storage unit 53, the process proceeds to step S59.

In step S59, the reduction seam determination unit 54 reads the cumulative energy map stored in the cumulative energy map storage unit 53, searches the pixel with the minimum cumulative energy at the lowermost stage, and sets the end of the reduction seam as the lower end. The reduction seam determination unit 54 repeatedly searches the pixels sequentially from the pixel located at the lower end of the reduction seam to the pixel located at the upper end thereof among the pixels adjacent upward to the pixels of interest, that is, the pixels adjacent right above, immediately above, and left above the pixels of interest. Then, the reduction seam determination unit 54 determines the path binding the sequentially searched pixels as the reduction seam, supplies the information regarding the reduction seam to both the partial image search unit 32 and the maximum energy value insertion unit 55.

That is, in the case of the cumulative energy map shown in the right upper part of FIG. 8, the minimum value of the cumulative energy at the lowermost stage is 4 indicated by a circle in FIG. 8 and a pixel (2, 2) has energy 1. That is, the pixel (2, 2) is located at the lower end of the reduction seam. The minimum cumulative energy is 3 between the energies of the pixel (2, 1) and the pixel (1, 1) adjacent upward to the pixel (2, 2), and the pixel (1, 1) has energy 2. Moreover, the minimum cumulative energy is 1 among the energies of the pixel (0, 0), the pixel (1, 0) and the pixel (2, 0) adjacent upward to the pixel (1, 1), and the pixel (0, 0) has energy 1.

The sequentially cumulated energy becomes the minimum along the path formed by the pixel (2, 2), the pixel (1, 1), and the pixel (0, 0) searched sequentially from the pixel (2, 2) located at the lower end to the pixel (0, 0) located at the upper end. Therefore, the path formed by the pixel (2, 2), the pixel (1, 1), and the pixel (0, 0) becomes a path, along which the variation in the pixel value or the luminance value between the adjacent pixels is the minimum, on the reduced image, that is, becomes the reduction seam. Accordingly, the reduction seam determination unit 54 determines the path formed based on the information regarding the coordinates of the searched pixels as the reduction seam.

In step S60, the maximum energy value insertion unit 55 reads the reduced image energy map stored in the reduced image energy map buffer 51, and inserts and updates the maximum value into the energy of each pixel forming the reduction seam determined by the reduction seam determination unit 54. As a consequence, the pixels with the maximum value can be pixels scarcely selected as the pixels forming the reduction seam in the subsequent process. Consequently, when a plurality of reduction seams are selected, the same pixels are prevented from being included in the plurality of reduction seams due to intersection or the like of the reduction seams. Accordingly, when the pixels belonging to the reduction seams are deleted or added, a pixel difference can be prevented from occurring.

The method of calculating the reduction seam by the process described with reference to the flowchart of FIG. 5 is generally a method called a dynamic programming method. However, the reduction seam may be calculated by a greedy method described below.

### Partial Image Search Process

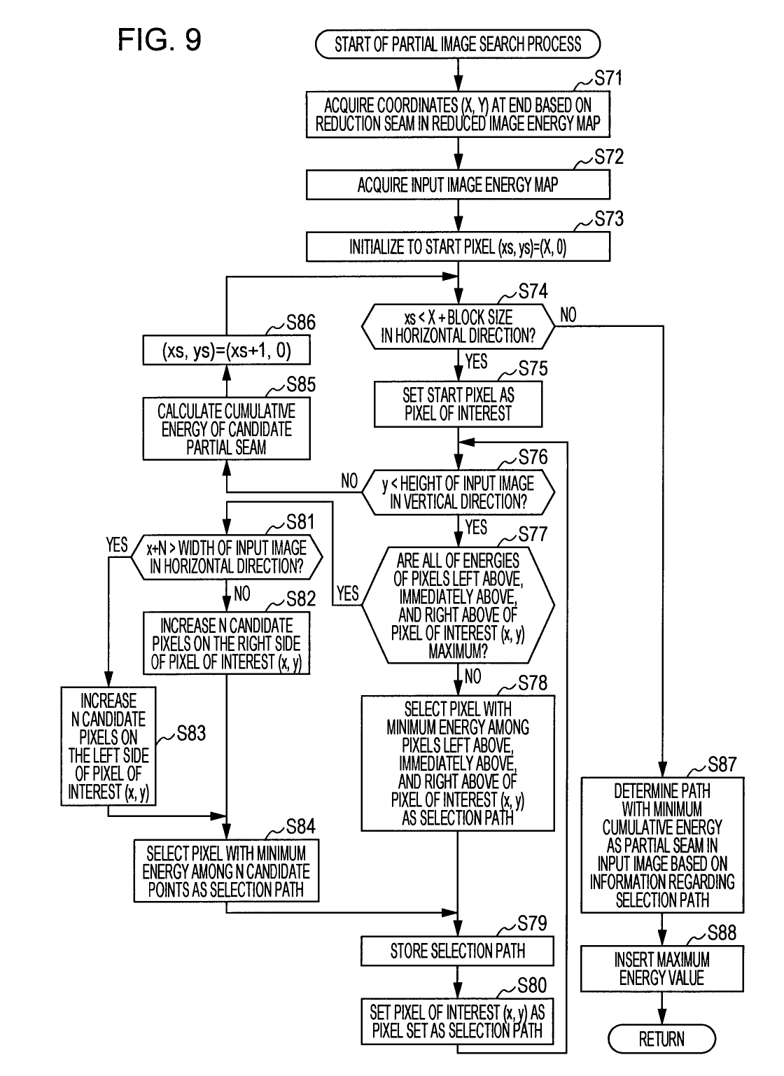

Next, the partial image search process will be described with reference to the flowchart of FIG. 9.

In step S71, the adjacent energy comparison unit 72 acquires the coordinates of a pixel at the end of the input image based on the reduction seam calculated based on the reduced image energy map by the above-described entire image search process. That is, the reduction seam is obtained based on the reduction image in which the block with a plurality of pixels (for example, m by n pixels) of the input image is set to one pixel, that is, a low-resolution image. Accordingly, the pixels forming the calculated reduction seam on the reduced image correspond to the block with a plurality of pixels in the input image. The adjacent energy comparison unit 72 calculates the coordinates (X, Y) of a pixel (block) forming the reduction seam at one end of the input image in the horizontal direction. For example, the coordinates of the pixel at the other end in the horizontal direction are calculated as (X+m), since the size of the block is known.

In step S72, the input image energy map buffer 71 reads and temporarily stores the input image energy map stored in the input image energy map storage unit 13.

In step S73, the adjacent energy comparison unit 72 sets a start pixel (xs, ys) of a candidate of the partial seam as a pixel (X, 0) based on the coordinates at the end of the reduction seam.

In step S74, the adjacent energy comparison unit 72 determines whether the xs coordinate of the start pixel (xs, ys) is smaller than (X+m) (m: block size in the horizontal direction). For example, when the xs coordinate is smaller than (X+m), the process proceeds to step S75.

In step S75, the adjacent energy comparison unit 72 sets the start pixel (xs, ys) as the pixel of interest (x, y)

In step S76, the adjacent energy comparison unit 72 determines whether the y coordinate of the pixel of interest (x, y) is smaller than the height of the input image in the vertical direction. For example, when the y coordinate is smaller than the height of the input image in the vertical direction, the process proceeds to step S77.

In step S77, the adjacent energy comparison unit 72 reads the input image energy map from the input image energy map buffer 71 and determines whether all of the energies of a pixel (x−1, y+1) adjacent left below the pixel of interest (x, y), a pixel (x, y+1) adjacent immediately below the pixel of interest (x, y), and a pixel (x+1, y+1) adjacent right below the pixel of interest (x, y) are the maximum energy value. For example, when all of the energies of the pixel (x−1, y+1) adjacent left below the pixel of interest (x, y), the pixel (x, y+1) adjacent immediately below the pixel of interest (x, y), and the pixel (x+1, y+1) adjacent right below the pixel of interest (x, y) are not the maximum energy value, the process proceeds to step S78.

In step S78, the adjacent energy comparison unit 72 notifies the selection path setting unit 74 of information regarding the pixel of interest (x, y) and information regarding the energies of the pixel (x−1, y+1) adjacent left below the pixel of interest (x, y), the pixel (x, y+1) adjacent immediately below the pixel of interest (x, y), and the pixel (x+1, y+1) adjacent right below the pixel of interest (x, y). The selection path setting unit 74 sets, as the selection path from the pixel of interest (x, y), the information regarding the pixel of interest (x, y) and the pixel with the minimum energy among the energies of the pixel (x−1, y+1) adjacent left below the pixel of interest (x, y), the pixel (x, y+1) adjacent immediately below the pixel of interest (x, y), and the pixel (x+1, y+1) adjacent right below the pixel of interest (x, y).

In step S79, the selection path setting unit 74 stores the information regarding the selection path in correspondence to the set pixel of interest (x, y) in the selection path storage unit 75.

In step S80, the adjacent energy comparison unit 72 sets the coordinates of the pixel of interest (x, y) as the coordinates selected as the selection path. That is, the adjacent energy comparison unit 72 sets the coordinates of the pixel with the minimum energy as the coordinates of the subsequent pixel of interest (x, y) among the pixel (x−1, y+1), the pixel (x, y+1), and the pixel (x+1, y+1). The process returns to step S76.

That is, the processes from step S76 to step S80 are repeated until the y coordinate reaches the height of the input image in step S76. For example, when it is determined that all of the energies of the pixel (x−1, y+1), the pixel (x, y+1), and the pixel (x+1, y+1) respectively adjacent left below, immediately below, and right below the pixel of interest (x, y) are not the maximum energy value in step S77, the following processes are sequentially performed by the processes from step S76 to step S80.

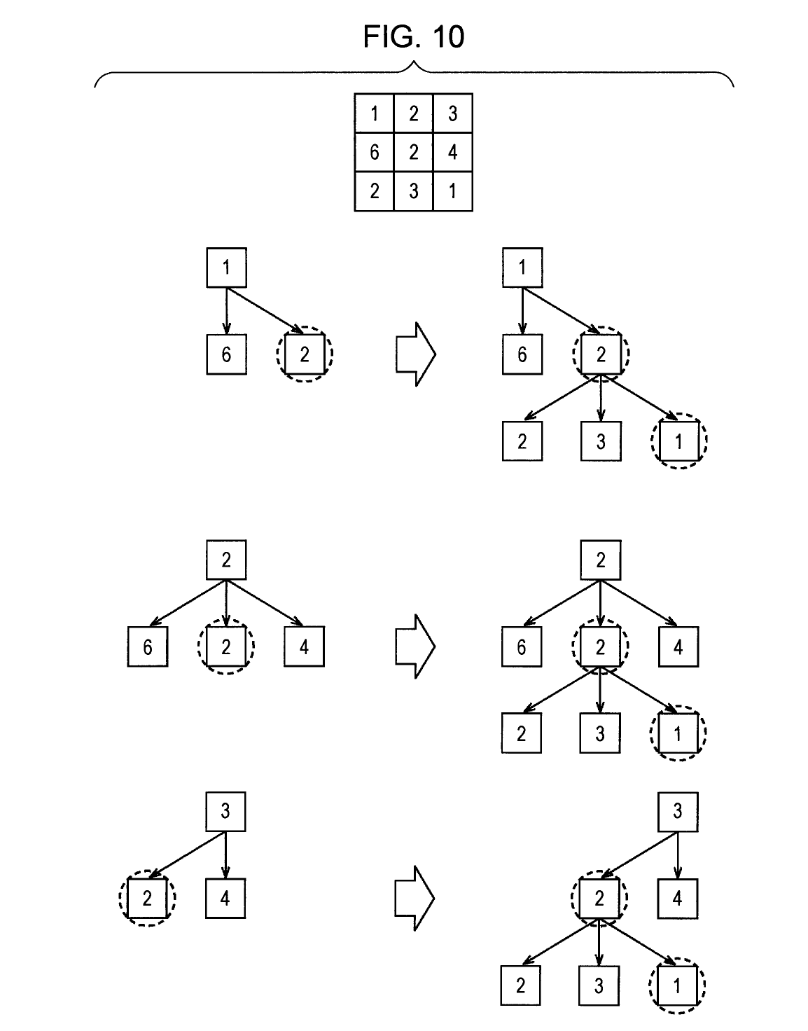

For example, in a case of the input image energy map shown in the uppermost part of FIG. 10, the pixel with energy 1 located at left upper end is initially set as the pixel of interest. At this time, since there is no pixel adjacent left below the pixel of interest, the pixel with the smaller energy is a pixel with energy 2 surrounded by a dotted line, as shown in the left side of the second part of FIG. 10, between the pixels located immediately below and right below the pixel of interest by the process of step S77, and this pixel is selected as the selection path.

In the subsequent process, since a pixel with energy 2 becomes the pixel of interest, a pixel with the minimum energy among the pixels adjacent left below, immediately below, and right below the pixel of interest is a pixel with energy 1 surrounded by a dotted line, as shown in the right side of the second part of FIG. 10, and this pixel is selected as the selection path.

Then, since the y coordinate reaches the height of the input image by the above process, the path, which is formed by a pixel group formed by sequentially connecting the pixel with energy 1 located at the left upper end, the pixel with energy 2 located in the middle, and the pixel with energy 1 located right below on the assumption that the pixel with energy 1 located at the left above is the start pixel of the partial seam, is set as a candidate of the partial seam in the input image energy map in FIG. 10, as shown in the right side of the second part of FIG. 10.

In step S76, when it is determined that the y coordinate is not smaller than the height of the input image and the y coordinate reaches the height of the input image, the process proceeds to step S85. In step S85, the selection path setting unit 74 calculates energy cumulative values of a plurality of pixel groups forming the paths set as candidates of the partial seam. Moreover, the selection path setting unit 74 stores information regarding the pixel group forming the candidate of the partial seam and the calculated cumulative value in correspondence with the start coordinates (xs, ys) in the selection path storage unit 75. That is, the candidate of the partial seam identified by the start coordinates (xs, ys) is stored as the information regarding the pixel group selected as the selection path in correspondence with the start coordinates (xs, ys) together with the cumulative energy in the selection path storage unit 75.

In step S86, the adjacent energy comparison unit 72 increases the xs coordinate of the start coordinates (xs, ys) by one, and the process returns to step S74.

Therefore, in the case of the input image energy map shown in the uppermost part of FIG. 10, pixels with energies 1, 2, and 3 from the left side of the upper stage are start pixels. Accordingly, when the processes from step S74 to step S80, the process of step S85, and the process of step S86 are repeated, the candidates of the partial seam are calculated for the pixels having the start coordinates, as below, and having energies 1, 2, and 3, in the case of FIG. 10.

The candidate of the partial seam in which the pixel with energy 1 is the start pixel is formed by the pixel with energy 1 located at the left upper end of the input image energy map shown in the second part of FIG. 10, as described above, the pixel with energy 2 located in the middle, and the pixel with energy 1 located at the right lower end. This candidate of the partial seam has cumulative energy 4. Moreover, the candidate of the partial seam in which the pixel with energy 2 is the start pixel is formed by the pixel with energy 2 located in the middle of the input image energy map shown in the left and right sides of third part of FIG. 10, the pixel with energy 2 located in the middle, and the pixel with energy 1 located at the right lower end. This candidate of the partial seam has cumulative energy 5. Furthermore, the candidate of the partial seam in which the pixel with energy 3 is the start pixel is formed by the pixel with energy 3 located at the right upper end of the input image energy map shown in the left and right sides of fourth part of FIG. 10, the pixel with energy 2 located in the middle, and the pixel with energy 1 located at the right lower end. This candidate of the partial seam has cumulative energy 6.

When it is determined that the xs coordinate of the start coordinates (xs, ys) is not smaller than (X+m), that is, exceeds the block calculated as the reduction seam in step S74, the process proceeds to step S87.

In step S87, the partial seam determination unit 76 determines the partial seam with the minimum cumulative energy as the partial seam from the candidates of the partial seam stored in the selection path storage unit 75, and stores information regarding the determined partial seam in the partial seam storage unit 77. Simultaneously, the partial seam determination unit 76 supplies the information regarding the determined partial seam to the maximum energy value insertion unit 81.

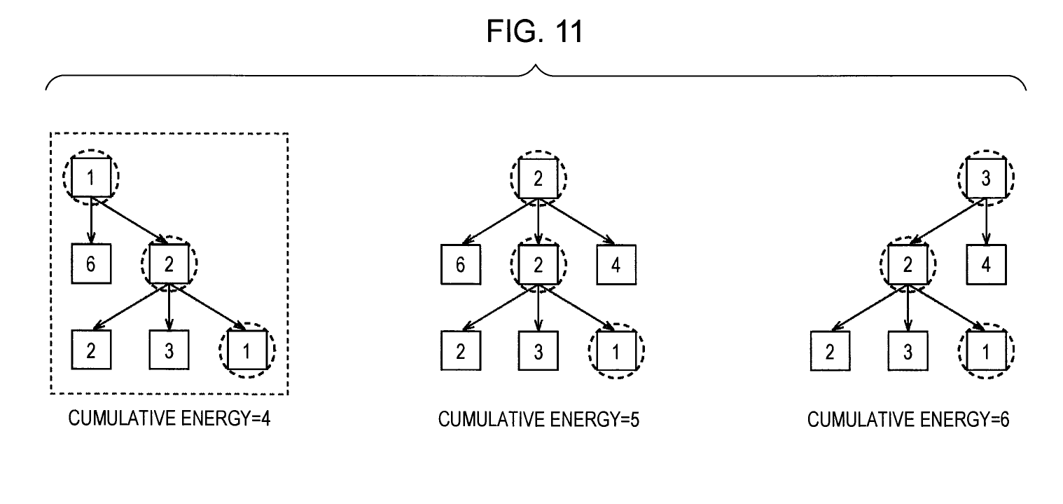

That is, in the input image energy map shown in the uppermost part of FIG. 10, the start coordinates shown in the second part of FIG. 10 have the smallest cumulative energy of the candidate of the partial seam in which the pixel with energy 1 located at the left upper end is the start pixel, and thus is determined as the partial seam, as shown in FIG. 11. In FIG. 11, the path which corresponds to the second part of FIG. 10 and is surrounded by a dotted line shown in the left side is selected as the partial seam through comparison of the cumulative energies of the candidates of the partial seam shown in the second, third, and fourth parts of FIG. 10 in order from the left side.

In step S88, the maximum energy value insertion unit 81 reads the input image energy map, inserts the maximum energy value as the energy of the coordinates of the pixel forming the partial seam, and then ends the process.

On the other hand, when it is determined that all of the energies of the pixel (x−1, y+1) adjacent left below the pixel of interest (x, y), the pixel (x, y+1) adjacent immediately below the pixel of interest (x, y), and the pixel (x+1, y+1) adjacent right below the pixel of interest (x, y) are the maximum energy value in step S77, the process proceeds to step S81.

In step S81, the adjacent energy comparison unit 72 notifies the non-adjacent energy comparison unit 73 that all of the energies of the pixels adjacent left below, immediately below, and right below the pixel of interest are the maximum. The non-adjacent energy comparison unit 73 determines whether the position (x+N) of the x coordinate obtained by adding N pixels to the x coordinate of the pixel of interest (x, y) is within the input image. For example, when the position (x+N) of the x coordinate obtained by adding N pixels to the x coordinate of the pixel of interest (x, y) is within the input image in step S81, the process proceeds to step S82.

In step S82, the non-adjacent energy comparison unit 73 sets (N-1) pixels continuously present on the right side from the pixel adjacent right below the pixel of interest, as the candidates used to select the selection path.

On the other hand, when the position (x+N) of the x coordinate obtained by adding N pixels to the x coordinate of the pixel of interest (x, y) is not within the input image in step S81, the process proceeds to step S84.

In step S84, the non-adjacent energy comparison unit 73 sets (N-1) pixels continuously present on the left side from the pixel adjacent left below the pixel of interest, as the candidates used to select the selection path.

In step S83, the non-adjacent energy comparison unit 73 selects the pixels with the minimum energy as the selection path from among the (N-1) pixels continuously present on the right side from the pixel adjacent right below the pixel of interest and the (N-1) pixels continuously present on the left side from the pixel adjacent left below the pixel of interest.

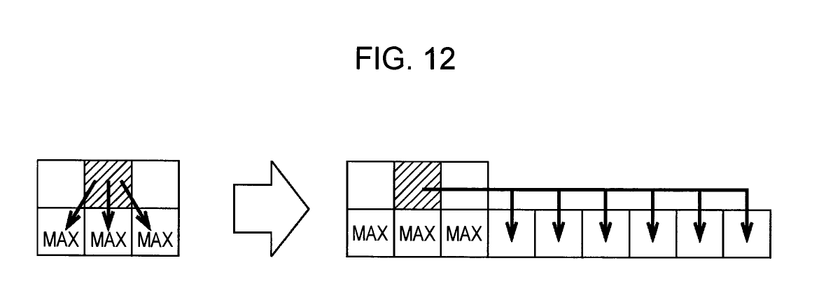

That is, when the pixels adjacent right below, immediately below, and left below the pixel of interest have the maximum energy value within the input image, as shown in the left side of FIG. 12, the non-adjacent energy comparison unit 73 treats the (N-1) pixels continuously adjacent rightward to the pixel adjacent right below the pixel of interest as the pixels adjacent right below, immediately below, and left below of the pixel of interest, as shown in the right side of FIG. 12. In FIG. 12, (N-1) pixels=6 pixels are shown.

As this description has been made in the entire image search process, the pixel with the maximum energy value is a pixel which is highly likely to be selected as the partial seam, since the maximum energy value is also given to the pixels belonging to the calculated partial seam.

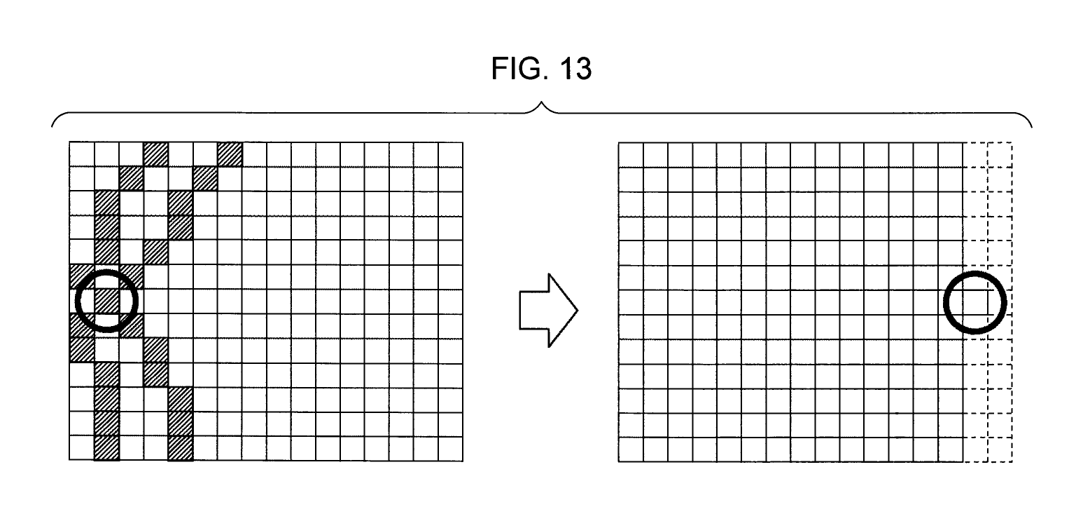

For example, when a plurality of partial seams is selected, as shown in the left side of FIG. 13, there is a pixel belonging to both the partial seams at the intersection position when the partial seams intersect each other. In this case, when the pixel calculated as the plurality of partial seams is deleted, as shown in the right side of FIG. 13, the pixels may not be deleted by the number of partial seams in a row or a column including the pixel repeatedly belonging to the plurality of partial seams. As a consequence, a row or a column including the number of pixels different from that of another row or another column occurs, and thus unnecessary pixels may occur.

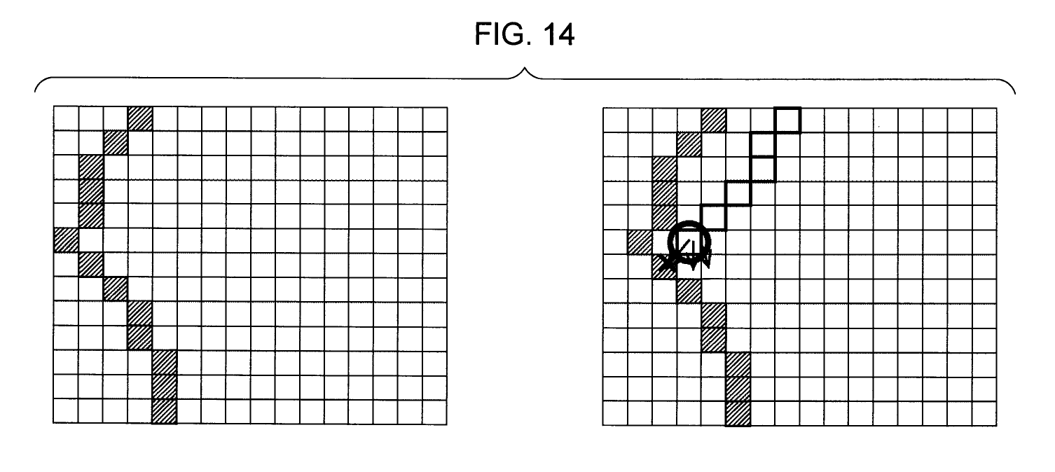

For example, the energy maximum value indicated by a black color shown on the right side of FIG. 14 is set for the temporarily calculated partial seam indicated by diagonal lines shown on the left side of FIG. 14. In this case, even when the partial seam indicated by a thick line shown on the right side of FIG. 14 is calculated and the pixel located left below the pixel of interest indicated by a circle has the maximum energy value, the pixels located immediately below and right below the pixel of interest do not have the maximum value. Therefore, since either of the pixels can be selected as the selection path, the partial seams can be set so as not to intersect each other.

However, when the process of step S78 is simply performed, as shown in the left side of FIG. 10, either of pixels with the maximum energy value is selected as the selection path, and thus an unnecessary pixel may occur.

Accordingly, when the pixels adjacent left below, immediately below, and right below the pixel of interest are pixels with the maximum energy value which are likely to be already calculated as the partial seam by performing the processes from step S82 to step S84, these pixels are excluded from the candidate of the selection path. In addition, a plurality of discontinuous pixels which is not adjacent to the pixel of interest and is adjacent to the pixels adjacent to the pixel of interest are set as candidates of the selection path. That is, the pixels which are actually not directly adjacent to the pixel of interest are treated as the pixels adjacent to the pixel of interest, and thus are considered as the candidates of the selection path. Among the pixels which are not directly adjacent to the pixel of interest and are the candidates of the selection path, the pixel with the minimum energy value is selected as the selection path. As a consequence, since there is low possibility that the same pixel becomes the pixel forming the plurality of partial seams, a so-called unnecessary pixel rarely occurs.

Then, referring back to the flowchart of FIG. 4, the description will be made.

When the partial image search process ends in step S32 and the partial seam is determined, the process proceeds to step S33.

In step S33, the simultaneously processed seam number determination unit 78 determines whether the total number of partial seams stored in the partial seam storage unit 77 reaches the number of simultaneously processed seams. For example, when it is determined that the total number of partial seams stored in the partial seam storage unit 77 reaches the number of simultaneously processed seams in step S33, the process proceeds to step S34.

In step S34, the intra-block partial seam number determination unit 79 determines whether the number of partial seams searched within the block forming the currently processed reduction seam among the partial seams stored in the partial seam storage unit 77 reaches the predetermined number of partial seams set in the block. For example, when the number of partial seams searched within the block forming the currently processed reduction seam among the stored partial seams does not reach the predetermined number of partial seams set in the block in step S34, the process returns to step S32. That is, since the number of partial seams originally calculated within the block forming the reduction seam is a predetermined number, the processes of step S32 and step S33 are repeated so as to continuously search the partial seams within the same block until the number of partial seams reaches the predetermined number.

On the other hand, when the number of partial seams searched within the block forming the currently processed reduction seam among the stored partial seams exceeds the predetermined number of partial seams set in the block in step S34, the process returns to step S31. That is, when the number of partial seams reaches the predetermined number of partial seams set within the block, the process returns to step S31 due to the fact that it is necessary to newly calculate a reduction seam again by the entire image search process and to perform the separate partial image search process on the newly calculated reduction seam.

For example, when it is determined that the total number of partial seams reaches the number of simultaneously processed seams in step S33, the process proceeds to step S35. In step S35, the simultaneously processed seam number determination unit 78 controls the output unit 80 to output the information regarding all of the partial seams stored in the partial seam storage unit 77 to the processing unit 16.

The search process can be summarized as follows. That is, the entire image search process is first performed using the reduced image energy map corresponding to the reduced image in order to search the reduction seams. At this time, in the entire image search process, the reduction seams are searched according to the dynamic programming method, as described above. The reduction seam is calculated by the pixel unit for the reduced image, but the pixels of the reduced image correspond to the block of the plurality of pixels in the input image. Therefore, in terms of the input image, the reduction seam serves as the information restricting the search range of the partial seams to be calculated to some extent.

Next, the partial image search process is performed on the pixels in the range calculated as the reduction seam to calculate the partial seam. In the partial image search process, the partial seams are searched according to the greedy method. At this time, when the number of calculated partial seams is less than the predetermined number of simultaneously processed seams and the predetermined number of partial seams set within the block is calculated, the reduction seam is calculated again by the entire image search process and the partial image search process is repeated in the same way.

When the number of calculated partial seams reaches the number of simultaneously processed seams, the information regarding the calculated partial seams is output and the image is processed based on the output partial seams.

By the above process, the partial seams are searched to delete or add the image. The reduction seam is first searched by the entire image search process, and then only the partial seams, in which the pixel forming the end of the block of the searched reduction seam is the start pixel, are searched. Therefore, since the detailed search range of the partial seams in the entire input image can be restricted, it is possible to reduce a calculation amount compared to the case where the partial seams are searched from the entire input image.

In the search of the partial seams in which a pixel at the end forming the block of the reduction seam searched in the entire image search process is the start pixel, the greedy method is used instead of the dynamic programming method. Accordingly, it is possible to reduce the calculation amount.

### Dynamic Programming Method and Greedy Method

Hereinafter, the dynamic programming method and the greedy method will be described. The dynamic programming method refers to a process of searching the reduction seam in the above-described entire image search process. The greedy method refers to a process of searching the partial seam in the above-described partial image search process.

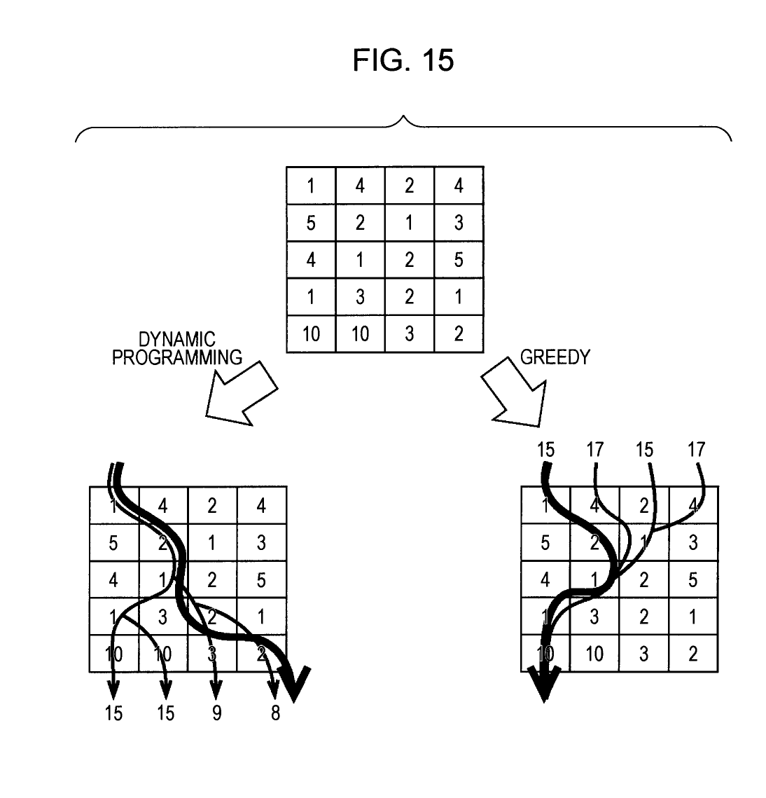

More specifically, when a seam with the minimum cumulative value of the energies of the pixels set as the selection path is searched in an energy map shown in the upper part of FIG. 15, the respective methods are used as follows. The energies of the pixels of the energy map shown in the upper part of FIG. 15 are 1, 4, 2, and 4 in the uppermost stage from the left side, are 5, 2, 1, and 3 in the second stage, are 4, 1, 2, and 5 in the third stage, are 1, 3, 2, and 1 in the fourth stage, and are 10, 10, 3, and 2 at the fifth stage.

When a seam is searched using the pixel with energy 1 located at the uppermost stage and the leftmost side as a start pixel, the cumulative energy map is first generated in the dynamic programming method. That is, the cumulative energy map is generated by sequentially downward repeating the process of cumulating the minimum energies among the energies of the pixels adjacent left above, immediately above and right above each pixel in the second stage from the upper side. As shown in the left lower part of FIG. 15, the seam, where the pixel with energy 1 located at the uppermost stage and leftmost side is the start pixel of a pixel group forming the selection path sequentially binding the pixel with the minimum cumulative energy among the end pixels and the start pixel, is selected as a candidate according to the cumulative energy map. The seam with the minimum cumulative energy is finally searched among the candidate seams calculated for all start pixels. As shown in the left lower part of FIG. 15, the seam with cumulative energy 8 indicated by a thick line is selected. As shown in the left lower part of FIG. 15, the cumulative energies of the pixels in the fifth stage are 15, 15, 9, and 8 from the left side.

According to the greedy method, on the other hand, as shown in the right lower part of FIG. 15, the pixels with the minimum energy among the energies of the pixels adjacent left below, immediately below, and right below each pixel are sequentially selected as the selection path in the energy map. Only one candidate seam is calculated from each start pixel and the seam with the minimum cumulative energy is finally selected from among the cumulative energies. As shown in the right lower part of FIG. 15, the cumulative energies of the seams of the start pixels in the uppermost stage are 15, 17, 15, and 17 for the respective start pixels from the left side. Accordingly, the seams of the start pixels with energy 1 or 2 in the uppermost stage are finally selected.

In comparison to the above processes, the cumulative energy map is temporarily calculated, the cumulative energies of the seams from all of the start pixels to all of the end pixels are compared to each other, and then the seam is selected according to the dynamic programming method. Therefore, as shown in the left lower part of FIG. 15, the seam with the minimum cumulative energy is selected with higher precision compared to the greedy method. However, the calculation amount is large, since the cumulative energy map is temporarily calculated and then the cumulative energies of the seams from all of the start pixels to all of the end pixels are calculated. In contrast, according to the greedy method, it is not necessary to calculate the cumulative energy map and the respective pixels are selected as the selection path under a given condition. Therefore, the calculation amount can be reduced. As shown in the right lower part of FIG. 15, however, the selection path is determined only for each pixel. Therefore, in effect, it is difficult to search the seam generated from the path along which the cumulative energy is the minimum.

In this embodiment, however, the dynamic programming method with higher precision is used in the entire image search process for the reduced image, thereby calculating the calculated reduction seam with relatively high precision. Since the entire image search process is performed for the reduced image according to the dynamic programming method, the calculation amount can be reduced compared to the process on the input image. Moreover, since the partial image search process of using the greedy method is performed only for the start pixels calculated as the reduction seam within the range, the partial seam is searched using the information regarding the reduction seam generated with the small calculation amount and calculated with relatively high precision. Therefore, the calculation speed can be improved while preventing the search precision of the partial seam from deteriorating.

When it is intended to improve the calculation speed, the greedy method may be used in the entire image search process. That is, when the greedy method is used in the entire image search process, it is not necessary to calculate the cumulative energy map or to compare the cumulative energies from all of the start pixels to all of the end pixels to each other and search the seams. Therefore, the calculation speed can be further improved.

The example has hitherto been described in which the seam is searched downward in the vertical direction in the input image. However, the pixels can be deleted or inserted in the horizontal direction by searching the seam in the horizontal direction in the same way. Moreover, by combining these methods, the input image can be reduced or expanded in the horizontal direction and the vertical direction.

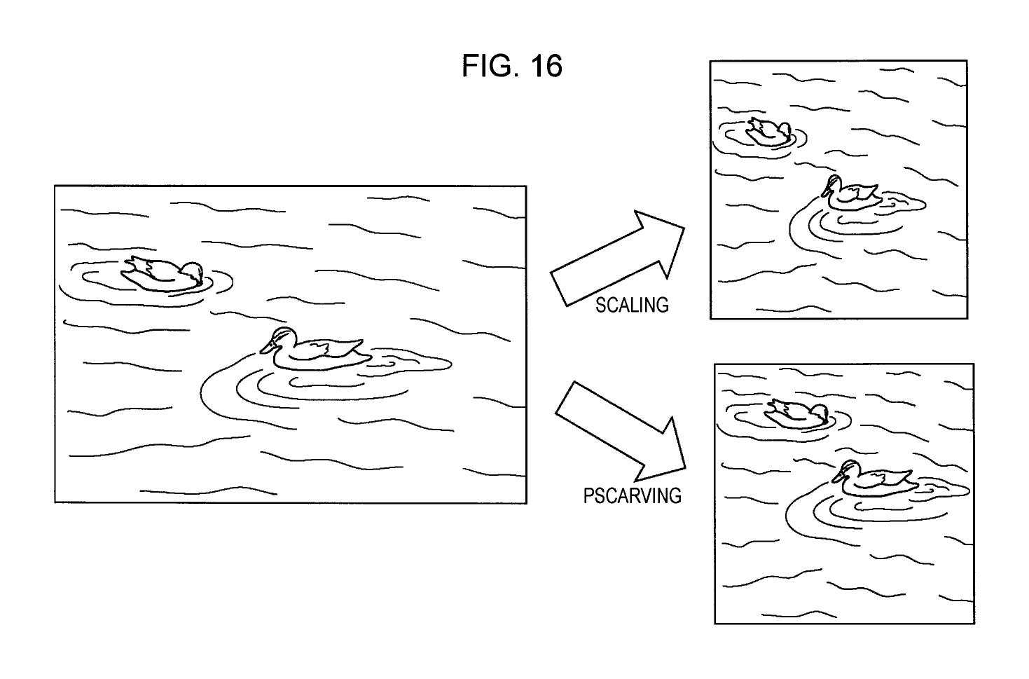

For example, when an input image formed by photographing two water birds shown in the left part of FIG. 16 is reduced in the horizontal direction and the vertical direction by predetermined scaling, as in an example according to the related art, the water birds are also reduced in the image according to an image reduction ratio, as shown in the right upper part of FIG. 16. However, when the above-described processes are used, as shown in the right lower part of FIG. 16, the image is reduced, but the sizes of the water birds are reduced less than the reduction ratio of the entire image. As a consequence, the size of the image is reduced, but a variation in the size of the water birds as subjects can be made to be smaller.

The above-described series of image processings may be executed by hardware or software. When the series of processes is executed by software, a program implementing the software is installed in a computer embedded with dedicated hardware or a computer such as a general personal computer, capable of installing various programs and executing various functions, from a program recording medium.

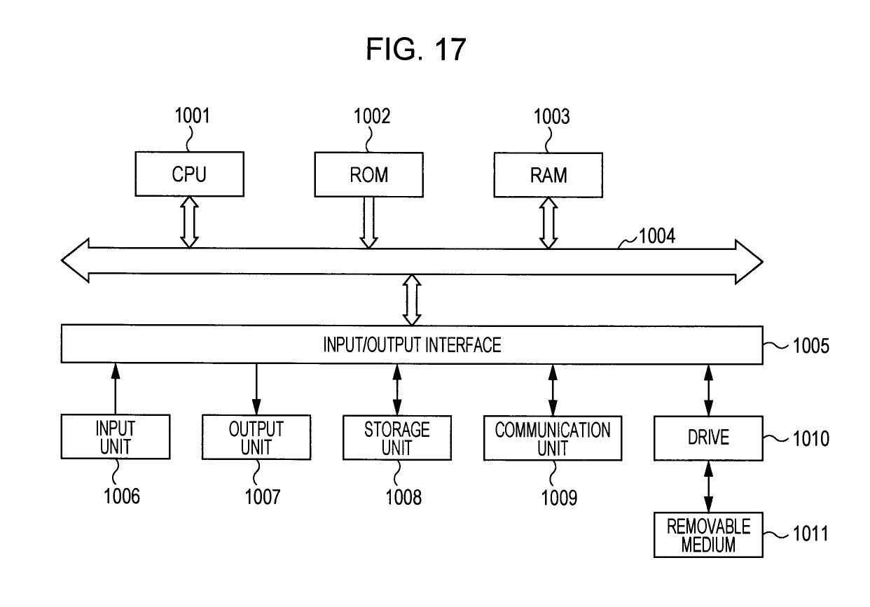

FIG. 17 is a diagram illustrating an exemplary configuration of a general personal computer. The personal computer has a CPU (Central Processing Unit) 1001 therein. An input/output interface 1005 is connected to the CPU 1001 via a bus 1004. A ROM (Read Only Memory) 1002 and a RAM (Random Access Memory) 1003 are connected to the bus 1004.

An input unit 1006 formed by an input device such as a keyboard or a mouse inputting an operation command of a user, an output unit 1007 outputting a processed operation screen or a processed image to a display device, a storage unit 1008 formed by a hard disk drive or the like storing programs or various kinds of data, and a communication unit 1009 formed by a LAN (Local Area Network) adapter and performing a communication process via a network such as the Internet which is a representative example are connected to the input/output interface 1005. A drive 1010 reading and writing data from and to a removable medium 1011 such as a magnetic disk (including a flexible disk), an optical disk (including a CD-ROM (Compact Disc-Read Only Memory) and a DVD (Digital Versatile Disc)), a magneto-optical disk (including an MD (Mini Disc)), or a semiconductor memory is connected to the input/output interface 1005.

The CPU 1001 executes various kinds of processes according to a program stored in the ROM 1002 or a program read from the removable medium 1011 such as a magnetic disk, an optical disk, a magneto-optical disk, or a semiconductor memory, installed in the storage unit 1008, and loaded from the storage unit 1008 to the RAM 1003. The RAM 1003 appropriately stores data necessary for the CPU 1001 to execute various kinds of processing.

In the specification, steps describing the program stored in a recording medium include not only processes chronologically performed according to a described order but also processes executed in parallel or separately, although not necessarily executed chronologically.

In the specification, a system refers to the entire apparatus configured by a plurality of apparatuses.

The present application contains subject matter related to that disclosed in Japanese Priority Patent Application JP 2010-040699 filed in the Japan Patent Office on Feb. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
input image energy map generation means for generating an input image energy map from an input image based on energies of adjacent pixels of the input image;
reduced energy map generation means for generating a reduced energy map corresponding to a reduced image, which is formed by setting one block formed by a plurality of adjacent pixels of the input image as one pixel, by reducing the input image energy map;
reduction seam search means for searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map;
partial seam search means for searching a partial seam formed by binding pixels with a minimum cumulative value among a plurality of paths formed from a pixel located at one end, which forms an end of the reduction seam searched by the reduction seam search means, of the input image in the input image energy map to pixels located at the other end of the input image sequentially via the pixels adjacent in a direction of the other end;
input image energy map update means for updating the input image energy map by inserting and replacing a maximum energy value into the energies corresponding to all of the pixels, which form the partial seam searched by the partial seam search means, of the input image on the input image energy map; and
reduction expansion means for reducing or expanding the input image by deleting the pixels forming the partial seam searched by the partial seam search means from the input image or inserting pixels interpolated from the same pixels as neighboring pixels to the pixels forming the partial seam,
wherein when the partial seam search means searches the plurality of paths formed from the pixel located at the one end of the input image to the pixels located at the other end of the input image sequentially via the pixels adjacent in the direction of the other end, the partial seam search means forms the paths by setting the pixels with the minimum energy as the adjacent pixels among a predetermined number of pixels adjacent to the adjacent pixels when all of the adjacent pixels have the maximum energy value of the input image energy map.

2. The image processing apparatus according to claim 1, further comprising:
reduction image energy map update means for updating the reduced image energy map by inserting and replacing the maximum energy value into the energies corresponding to all of the pixels, which form the reduction seam searched by the reduction seam search means, of the reduced image on the reduced image energy map.

3. The image processing apparatus according to claim 1, wherein according to a greedy method or a dynamic programming method, the reduction seam search means searches the reduction seam formed by binding pixels of the path along which the cumulative energy value is minimum among the plurality of paths formed from the pixel located at one end of the reduced image to the pixels at the other end of the reduced image sequentially via the pixels adjacent in the direction of the other end in the reduced energy map.

4. The image processing apparatus according to claim 1, wherein according to a greedy method, the partial seam search unit searches the partial seam formed by binding the pixels with the minimum cumulative value of the energies of the pixels among the plurality of paths formed from the pixel located at one end, which forms the end of the reduction seam searched by the reduction seam search means, of the input image in the input image energy map to the pixels located at the other end of the input image sequentially via the pixels adjacent in the direction of the other end.

5. An image processing method of an image processing apparatus which includes
input image energy map generation means for generating an input image energy map from an input image based on energies of adjacent pixels of the input image,
reduced energy map generation means for generating a reduced energy map corresponding to a reduced image, which is formed by setting one block formed by a plurality of adjacent pixels of the input image as one pixel, by reducing the input image energy map,
reduction seam search means for searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map,
partial seam search means for searching a partial seam formed by binding pixels with a minimum cumulative value among a plurality of paths formed from a pixel located at one end, which forms an end of the reduction seam searched by the reduction seam search means, of the input image in the input image energy map to pixels located at the other end of the input image sequentially via the pixels adjacent in a direction of the other end,
input image energy map update means for updating the input image energy map by inserting and replacing a maximum energy value into the energies corresponding to all of the pixels, which form the partial seam searched by the partial seam search means, of the input image on the input image energy map, and
reduction expansion means for reducing or expanding the input image by deleting the pixels forming the partial seam searched by the partial seam search means from the input image or inserting pixels interpolated from the same pixels as neighboring pixels to the pixels forming the partial seam,
wherein when searching the plurality of paths formed from the pixel located at the one end of the input image to the pixels located at the other end of the input image sequentially via the pixels adjacent in the direction of the other end, the partial seam search means forms the paths by setting the pixels with the minimum energy as the adjacent pixels among a predetermined number of pixels adjacent to the adjacent pixels when all of the adjacent pixels have the maximum energy value of the input image energy map,
the image processing method comprising the steps of:
generating, by the input image energy map generation means, the input image energy map from the input image based on the energies of the adjacent pixels of the input image;
generating, by the reduced energy map generation means, the reduced energy map corresponding to the reduced image, which is formed by setting one block formed by the plurality of adjacent pixels of the input image as one pixel, by reducing the input image energy map;
searching, by the reduction seam search means, the reduction seam formed by binding the pixels of the path along which the cumulative energy value is minimum among the plurality of paths formed from the pixel located at one end of the reduced image to pixels located at the other end of the reduced image sequentially via the pixels adjacent in the direction of the other end in the reduced energy map;
searching, by the partial seam search means, the partial seam formed by binding the pixels with the minimum cumulative value of the energies of the pixels among the plurality of paths formed from the pixel located at one end, which forms an end of the reduction seam searched in the step of searching the reduction seam, of the input image in the input image energy map to the pixels located at the other end of the input image sequentially via the pixels adjacent in the direction of the other end;
updating, by the input image energy map update means, the input image energy map by inserting and replacing the maximum energy value into the energies corresponding to all of the pixels, which form the partial seam searched in the step of searching the partial seam, of the input image on the input image energy map; and
reducing or expanding, by the reduction expansion means, the input image by deleting the pixels forming the partial seam searched in the step of searching the partial seam from the input image or inserting the pixels interpolated from the same pixels as the neighboring pixels to the pixels forming the partial seam,
wherein when searching the plurality of paths formed from the pixel located at the one end of the input image to the pixels located at the other end of the input image sequentially via the pixels adjacent in the direction of the other end, the paths are formed in the step of searching the partial seam by setting the pixels with the minimum energy as the adjacent pixels among the predetermined number of pixels adjacent to the adjacent pixels when all of the adjacent pixels have the maximum energy value of the input image energy map.

6. A program causing a computer controlling an image processing apparatus which includes
input image energy map generation means for generating an input image energy map from an input image based on energies of adjacent pixels of the input image,
reduced energy map generation means for generating a reduced energy map corresponding to a reduced image, which is formed by setting one block formed by a plurality of adjacent pixels of the input image as one pixel, by reducing the input image energy map,
reduction seam search means for searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map,
partial seam search means for searching a partial seam formed by binding pixels with a minimum cumulative value among a plurality of paths formed from a pixel located at one end, which forms an end of the reduction seam searched by the reduction seam search means, of the input image in the input image energy map to pixels located at the other end of the input image sequentially via the pixels adjacent in a direction of the other end,
input image energy map update means for updating the input image energy map by inserting and replacing a maximum energy value into the energies corresponding to all of the pixels, which form the partial seam searched by the partial seam search means, of the input image on the input image energy map, and
reduction expansion means for reducing or expanding the input image by deleting the pixels forming the partial seam searched by the partial seam search means from the input image or inserting pixels interpolated from the same pixels as neighboring pixels to the pixels forming the partial seam,
wherein when searching the plurality of paths formed from the pixel located at the one end of the input image to the pixels located at the other end of the input image sequentially via the pixels adjacent in the direction of the other end, the partial seam search means forms the paths by setting the pixels with the minimum energy as the adjacent pixels among a predetermined number of pixels adjacent to the adjacent pixels when all of the adjacent pixels have the maximum energy value of the input image energy map,
to execute the steps of:
generating, by the input image energy map generation means, the input image energy map from the input image based on the energies of the adjacent pixels of the input image;
generating, by the reduced energy map generation means, the reduced energy map corresponding to the reduced image, which is formed by setting one block formed by the plurality of adjacent pixels of the input image as one pixel, by reducing the input image energy map;
searching, by the reduction seam search means, the reduction seam formed by binding the pixels of the path along which the cumulative energy value is minimum among the plurality of paths formed from the pixel located at one end of the reduced image to pixels located at the other end of the reduced image sequentially via the pixels adjacent in the direction of the other end in the reduced energy map;
searching, by the partial seam search means, the partial seam formed by binding the pixels with the minimum cumulative value of the energies of the pixels among the plurality of paths formed from the pixel located at one end, which forms an end of the reduction seam searched in the step of searching the reduction seam, of the input image in the input image energy map to the pixels located at the other end of the input image sequentially via the pixels adjacent in the direction of the other end;
updating, by the input image energy map update means, the input image energy map by inserting and replacing the maximum energy value into the energies corresponding to all of the pixels, which form the partial seam searched in the step of searching the partial seam, of the input image on the input image energy map; and
reducing or expanding, by the reduction expansion means, the input image by deleting the pixels forming the partial seam searched in the step of searching the partial seam from the input image or inserting the pixels interpolated from the same pixels as the neighboring pixels to the pixels forming the partial seam,
wherein when searching the plurality of paths formed from the pixel located at the one end of the input image to the pixels located at the other end of the input image sequentially via the pixels adjacent in the direction of the other end, the paths are formed in the step of searching the partial seam by setting the pixels with the minimum energy as the adjacent pixels among the predetermined number of pixels adjacent to the adjacent pixels when all of the adjacent pixels have the maximum energy value of the input image energy map.

7. An image processing apparatus comprising:
an input image energy map generation unit generating an input image energy map from an input image based on energies of adjacent pixels of the input image;
a reduced energy map generation unit generating a reduced energy map corresponding to a reduced image, which is formed by setting one block formed by a plurality of adjacent pixels of the input image as one pixel, by reducing the input image energy map;
a reduction seam search unit searching a reduction seam formed by binding pixels of a path along which a cumulative energy value is minimum among a plurality of paths formed from a pixel located at one end of the reduced image to pixels located at the other end of the reduced image sequentially via the pixels adjacent in a direction of the other end in the reduced energy map;
a partial seam search unit searching a partial seam formed by binding pixels with a minimum cumulative value among a plurality of paths formed from a pixel located at one end, which forms an end of the reduction seam searched by the reduction seam search unit, of the input image in the input image energy map to pixels located at the other end of the input image sequentially via the pixels adjacent in a direction of the other end;
an input image energy map update unit updating the input image energy map by inserting and replacing a maximum energy value into the energies corresponding to all of the pixels, which form the partial seam searched by the partial seam search unit, of the input image on the input image energy map; and
a reduction expansion unit reducing or expanding the input image by deleting the pixels forming the partial seam searched by the partial seam search unit from the input image or inserting pixels interpolated from the same pixels as neighboring pixels to the pixels forming the partial seam,
wherein when searching the plurality of paths formed from the pixel located at the one end of the input image to the pixels located at the other end of the input image sequentially via the pixels adjacent in the direction of the other end, the partial seam search unit forms the paths by setting the pixels with the minimum energy as the adjacent pixels among a predetermined number of pixels adjacent to the adjacent pixels when all of the adjacent pixels have the maximum energy value of the input image energy map.
